(19) United States
(12) Patent Application Publication
(10) Pub. No.: US 2016/0002082 A1
(43) Pub. Date: Jan. 7, 2016

(54) MULTIVALENT ION SEPARATING DESALINATION PROCESS AND SYSTEM

(71) Applicant: SALTWORKS TECHNOLOGIES INC., Vancouver (CA)

(72) Inventors: Xiangchun Yin, Vancouver (CA); Benjamin Stuart Sparrow, Vancouver (CA); Malcolm Man, Vancouver (CA)

(73) Assignee: SALTWORKS TECHNOLOGIES INC., Vancouver, BC (CA)

(21) Appl. No.: 14/768,410

(22) PCT Filed: Mar. 6, 2014
(86) PCT No.: PCT/CA2014/050184

§ 371 Date: Aug. 17, 2015

Related U.S. Application Data
(60) Provisional application No. 61/898,278, filed on Oct. 31, 2013.
(60) Provisional application No. 61/814,317, filed on Apr. 21, 2013.
(60) Provisional application No. 61/774,530, filed on Mar. 7, 2013.

(51) Int. Cl. C02F 9/00; C02F 1/469; C02F 1/52; C02F 1/44; C02F 1/42

(52) U.S. Cl. CPC C02F 9/00; C02F 1/441; C02F 1/42; C02F 1/52; C02F 1/4693; C02F 2001/422; C02F 2001/425; C02F 2201/46115

(57) ABSTRACT

A multivalent ion separating desalination system and associated process employs at least one multivalent ion separator subsystem to split sparingly soluble multivalent ion species from saltwater into highly soluble salts comprising multivalent cations and monovalent anions and salts comprising monovalent cations and multivalent anions.

### CROSS-REFERENCE TO RELATED APPLICATIONS

Pursuant to 35 U.S.C. §119(e), this application claims the benefit of provisional U.S. Patent Application No. 61/774,530, filed Mar. 7, 2013 and entitled “Multivalent Ion Separating Desalination System,” provisional U.S. Patent Application No. 61/814,317, filed Apr. 21, 2013 and entitled “Hybrid Electrodialysis Desalination System,” and provisional U.S. Patent Application No. 61/898,278, filed Oct. 31, 2013 and entitled “Multivalent Ion Separating Desalination System,” the entireties of all of which are hereby incorporated by reference herein.

### TECHNICAL FIELD

The present disclosure is directed at a multivalent ion desalination process and system. More particularly, the present disclosure is directed at a process and system comprising at least one multivalent ion separator for effective desalination of a scaling saltwater at a high recovery by separating sparingly soluble multivalent ion pairs into non-scaling monovalent-multivalent pairs.

### BACKGROUND

Desalination is being increasingly practiced to produce freshwater from saltwater. The most commonly practiced desalination processes are reverse osmosis (“RO”), thermal desalination, and electrodialysis (“ED”) or electrodialysis reversal (“EDR”).

In RO, water is forced through an osmotic membrane that rejects salts and allows water flux under pressures exceeding the osmotic pressure. RO is at present the most widely practiced saltwater desalination process, but is limited in its ability to process high salinity water with salt concentrations of 80,000 parts per million or more. Nanofiltration (“NF”) is similar to RO, although NF produces a permeate richer in monovalent ions than RO permeate.

In thermal desalination, water is evaporated and then condensed, sometimes in multiple stages, in order to recycle the latent heat of condensation. While this category of process can operate at high brine concentration levels, the energy input requirement tends to be large.

ED and EDR are water treatment processes that transfer salt ions across ion exchange membranes under the action of a galvanic potential. ED is performed using an electrodialysis stack comprising alternating anion exchange membranes and cation exchange membranes between two electrodes (an anode and a cathode). The galvanic potential is supplied as a voltage generated at the electrodes. Typical industrial ED stacks comprise two sets of chambers—diluent chambers and concentrate chambers. One water source is typically used to feed a diluent circuit and a concentrate circuit, which respectively comprise the diluent chambers and the concentrate chambers. During stack operation salts are transferred from the diluent to the concentrate chambers. Desalinated diluent is often the product water and the concentrate is eventually discharged.

Membrane-based desalination systems such as ED and EDR tend to have lower operating costs than thermal desalination systems. It can therefore be advantageous to use a membrane-based desalination system as a primary stage desalination system, and to then use a thermal desalination system, if necessary, as a secondary, downstream desalination system. Maximizing recovery and, accordingly, the concentration of any brine discharged from a desalination system is becoming particularly important for inland desalination systems due to evolving regulations directed at preventing brine discharge and the high cost of brine discharge management. The design of membrane-based desalination systems, however, is limited by the scaling of slightly soluble multivalent ion pairs such as CaSO₄, CaCO₃, and BaSO₄.

Inland brackish and industrial saltwaters are often high in scaling multivalent ion pairs comprising multivalent cations such as Ca²⁺, Mg²⁺, and Ba²⁺, and associated multivalent anions such as SO₄²⁻ and CO₃²⁻. The multivalent ion pairs may have solubility of less than 0.1% by mass. This implies that they can precipitate at low concentrations, limit recovery, and consequently be problematic for desalination systems. In some applications, highly soluble monovalent ionic species, such as NaCl, may not even be the major salt species. To address scaling, an ion exchange unit is usually placed upstream of membrane-based desalination systems to remove the scaling multivalent ions such as Ca²⁺ and SO₄²⁻. However, an ion exchange unit, such as an ion exchange bed or column, requires considerable maintenance, including the frequent addition of sodium chloride and hydrochloric acid to regenerate ion exchange resins. This maintenance adds costs to the desalination process. Adding sodium chloride and hydrochloric acid for regeneration purposes also produces a concentrated salt or acid wastewater, the management of which adds costs to the desalination process.

A need therefore exists to address the scaling associated with multivalent ion pairs in membrane-based desalination processes and systems.

### SUMMARY

According to a first aspect, there is provided a process for desalinating saltwater. The input saltwater comprises multivalent ion pairs and the process comprises circulating the input saltwater through a common fluid circuit comprising a multivalent cation-extracting branch and a multivalent anion-extracting branch, wherein a portion of the cation-extracting branch and a portion of the anion-extracting branch are distinct from each other; removing multivalent cations from the input saltwater when the input saltwater is in the portion of the cation-extracting branch distinct from the anion-extracting branch, wherein the multivalent cations are removed using a multivalent cation-extracting stack comprising alternating cation exchange membranes and monovalent anion exchange membranes; and removing multivalent anions from the input saltwater when the input saltwater is in the portion of the anion-extracting branch distinct from the cation-extracting branch, wherein the multivalent anions are removed using a multivalent anion-extracting stack comprising alternating anion exchange membranes and monovalent cation exchange membranes.

The process may further comprise transferring the multivalent cations removed from the input saltwater to a multivalent cation fluid circuit distinct from the common fluid circuit; and transferring the multivalent anions removed from the input saltwater to a multivalent anion fluid circuit distinct from the common fluid circuit and the multivalent cation fluid circuit.

The process may further comprise adding monovalent ion species to the input saltwater upstream of the portions of the anion-extracting and cation-extracting branches where the multivalent anions and cations are removed, respectively.

The process may further comprise periodically reversing polarity of one or both of the multivalent anion-extracting stack and multivalent cation-extracting stack to perform descaling, wherein reversing the polarity of either of the stacks comprises reversing the polarity of an electric field applied across that stack and swapping positions of concentrate and product chambers of that stack.

Reversing the polarity of either of the stacks may further comprise flushing the concentrate chambers of that stack with product water that has exited the product chambers of that stack.

Removing the multivalent cations from the input saltwater may generate product water and multivalent cation-rich water and removing the multivalent anions from the input saltwater may generate product water and multivalent anion-rich water, and the process may further comprise using reverse osmosis to further desalinate the product water generated from removing the multivalent cations and multivalent anions.

The process may further comprise generating a precipitate comprising multivalent ion species and a monovalent salt-rich brine by mixing the multivalent cation-rich and multivalent anion-rich waters.

The process may further comprise polishing the monovalent salt-rich brine by precipitating multivalent cations therefrom.

The process may further comprise using an electrodialysis stack (“monovalent salt-concentrating stack”), which comprises alternating monovalent anion exchange membranes and monovalent cation exchange membranes, to concentrate the monovalent salt-rich brine.

The process may further comprise adding the monovalent salt-rich brine, after it has been concentrated by the monovalent salt-concentrating stack, to the input saltwater upstream of the portions of the anion-extracting and cation-extracting branches where the multivalent anions and multivalent cations are removed, respectively.

According to another aspect, there is provided a system for desalinating input saltwater, which comprises a multivalent cation-extracting electrodialysis stack (“multivalent cation-extracting stack”) and a multivalent anion-extracting electrodialysis stack (“multivalent anion-extracting stack”). The multivalent cation-extracting stack comprises alternating cation exchange membranes and monovalent anion exchange membranes; and alternating product chambers and concentrate chambers bounded by the cation exchange membranes and monovalent anion exchange membranes, wherein the multivalent cation-extracting stack removes salts comprising multivalent cations and monovalent anions from its product chambers to its concentrate chambers while desalinating when sufficient voltage is applied across it. The multivalent anion-extracting stack comprises alternating anion exchange membranes and monovalent cation exchange membranes; and alternating product chambers and concentrate chambers bounded by the anion exchange membranes and the monovalent cation exchange membranes, wherein the multivalent anion-extracting stack removes salts comprising monovalent cations and multivalent anions from its product chambers to its concentrate chambers while desalinating when sufficient voltage is applied across it. The system also comprises an input saltwater source fluidly coupled to inlets of the product chambers of the multivalent cation-extracting and anion-extracting stacks to feed input saltwater to the inlets.

The input saltwater source may comprise a water tank, and outlets of the product chambers of the multivalent cation-extracting and anion-extracting stacks may be fluidly coupled to the water tank to form a common fluid circuit comprising the water tank and the product chambers of the multivalent cation-extracting and anion-extracting stacks.

The system may further comprise a multivalent cation tank fluidly coupled to an inlet and outlet of the concentrate chambers of the multivalent cation-extracting stack to form a multivalent cation fluid circuit; and a multivalent anion tank fluidly coupled to an inlet and outlet of the concentrate chambers of the multivalent anion-extracting stack to form a multivalent anion fluid circuit.

The system may further comprise a monovalent ion species addition subsystem comprising a reserve of at least one of a monovalent salt and a monovalent acid, the monovalent ion species addition subsystem fluidly coupled to the product chambers of the multivalent cation-extracting and anion-extracting stacks to add one or both of the monovalent salt and monovalent acid to the input saltwater.

The system may further comprise a desalination subsystem fluidly coupled to the product chambers of the multivalent cation-extracting and anion-extracting stacks such that product water exiting the product chambers of the multivalent cation-extracting and anion-extracting stacks can be further desalinated. The desalination subsystem may comprise one of a reverse osmosis device, a forward osmosis device, a nanofiltration device, an electrodialysis device, a thermal desalination device, and a membrane distillation device.

The system may further comprise a multivalent ion pair salt precipitating subsystem (“salt precipitating subsystem”) fluidly coupled to the concentrate chambers of the multivalent cation-extracting and anion-extracting stacks such that multivalent ion pairs extracted by the multivalent cation-extracting and anion-extracting stacks can be precipitated and discharged from the system.

The salt precipitating subsystem may output a monovalent ion rich brine, and the system may further comprise a multivalent salt precipitation polishing subsystem (“polishing subsystem”) fluidly coupled to the salt precipitating subsystem to receive the brine and configured to remove multivalent cations therefrom.

The salt precipitating subsystem may output a monovalent ion rich brine, and the system may further comprise a monovalent salt-concentrating electrodialysis stack (“monovalent salt-concentrating stack”) fluidly coupled to the salt precipitating subsystem to receive the brine and configured to concentrate the brine.

The monovalent salt-concentrating stack may be fluidly coupled to the product chambers of the multivalent cation-extracting and anion-extracting stacks and configured to add the brine after it has been concentrated to the input saltwater such that monovalent ion concentration of the input saltwater while in the multivalent cation-extracting and anion-extracting stacks is increased.

The monovalent salt-concentrating stack may comprise alternating monovalent anion exchange membranes and monovalent cation exchange membranes.

According to another aspect, there is provided a process for desalinating saltwater. The input saltwater comprises multivalent ion pairs and the process comprises separating the input saltwater into two streams; transferring either multivalent cations or multivalent anions from one of the streams to the other of the streams to cause one of the streams to comprise multivalent anion-rich water and the other of the streams to comprise multivalent cation-rich water, wherein the multivalent anion-rich water has a higher concentration of multivalent anions and a lower concentration of multivalent cations than the multivalent cation-rich water, and wherein the transferring is performed using a multivalent cation-extracting stack comprising alternating cation exchange membranes and monovalent anion exchange membranes or a multivalent anion-extracting stack comprising alternating anion exchange membranes and monovalent cation exchange membranes; desalinating the multivalent anion-rich water to generate a concentrated multivalent anion solution and product water; and desalinating the multivalent cation-rich water, separately from the multivalent anion-rich water, to generate a concentrated multivalent cation solution and product water.

Desalinating the multivalent anion-rich water and desalinating the multivalent cation-rich water may be performed by one of reverse osmosis, forward osmosis, nanofiltration, electrodialysis, thermal desalination, and membrane distillation.

The process may further comprise adding monovalent ion species to the input saltwater prior to transferring either multivalent cations or multivalent anions from one of the streams to the other of the streams.

The process may further comprise periodically reversing polarity of the multivalent anion-extracting stack or multivalent cation-extracting stack to perform descaling, wherein reversing the polarity either of the stacks comprises reversing the polarity of an electric field applied across that stack and swapping positions of concentrate and product chambers of that stack.

Reversing the polarity of either of the stacks may further comprise flushing the concentrate chambers of that stack with product water that has exited the product chambers of that stack.

The process may further comprise generating a precipitate comprising multivalent ion species and a monovalent salt-rich brine by mixing the concentrated multivalent anion solution and the concentrated multivalent cation solution.

The process may further comprise polishing the monovalent salt-rich brine by precipitating multivalent cations therefrom.

The process may further comprise using an electrodialysis stack (“monovalent salt-concentrating stack”), which comprises alternating monovalent anion exchange membranes and monovalent cation exchange membranes, to concentrate the monovalent salt-rich brine.

The process may further comprise adding the monovalent salt-rich brine, after it has been concentrated by the monovalent salt-concentrating stack, to the input saltwater upstream of the portions of the anion-extracting and cation-extracting branches where the multivalent anions and multivalent cations are removed, respectively.

According to another aspect, there is provided a system for desalinating input saltwater. The system comprises a multivalent ion separator subsystem, comprising either (i) a multivalent cation-extracting electrodialysis stack (“multivalent cation-extracting stack”), comprising: alternating cation exchange membranes and monovalent anion exchange membranes; and alternating product chambers and concentrate chambers bounded by the cation exchange membranes and monovalent anion exchange membranes, wherein the multivalent cation-extracting stack removes salts comprising multivalent cations and monovalent anions from its product chambers to its concentrate chambers while desalinating when sufficient voltage is applied across it; or (ii) a multivalent anion-extracting electrodialysis stack (“multivalent anion-extracting stack”), comprising: alternating anion exchange membranes and monovalent cation exchange membranes; and alternating product chambers and concentrate chambers bounded by the anion exchange membranes and the monovalent cation exchange membranes, wherein the multivalent anion-extracting stack removes salts comprising multivalent anions and monovalent cations from its product chambers to its concentrate chambers while desalinating when sufficient voltage is applied across it. The system further comprises first and second desalinator subsystems fluidly coupled to the product chambers and concentrate chambers of the multivalent ion separator subsystem, respectively, wherein each of the desalinator subsystems outputs product water and a concentrated multivalent ion solution while desalinating.

Each of the desalinator subsystems may comprise one of a reverse osmosis device, a forward osmosis device, a nanofiltration device, an electrodialysis device, a thermal desalination device, and a membrane distillation device.

The system may further comprise a monovalent ion species addition subsystem comprising a reserve of at least one of a monovalent salt and a monovalent acid, the monovalent ion species addition subsystem fluidly coupled to the product chambers of the multivalent ion separator subsystem to add one or both of the monovalent salt and monovalent acid to the input saltwater.

The system may further comprise a multivalent ion pair salt precipitating subsystem (“salt precipitating subsystem”) fluidly coupled to the first and second desalinators to receive the concentrated multivalent ion solution that each of the desalinators outputs and configured to precipitate and discharge multivalent ion pairs from the system.

The salt precipitating subsystem may output a monovalent ion rich brine, and the system may further comprise a multivalent salt precipitation polishing subsystem (“polishing subsystem”) fluidly coupled to the salt precipitating subsystem to receive the brine and configured to remove multivalent cations therefrom.

The salt precipitating subsystem may output a monovalent ion rich brine, and the system may further comprise a monovalent salt-concentrating electrodialysis stack (“monovalent salt-concentrating stack”) fluidly coupled to the salt precipitating subsystem to receive the brine and configured to concentrate the brine.

The monovalent salt-concentrating stack may be fluidly coupled to the product chambers of the multivalent cation-extracting and anion-extracting stacks and configured to add the brine after it has been concentrated to the input saltwater such that monovalent ion concentration of the input saltwater while in the multivalent cation-extracting and anion-extracting stacks is increased.

The monovalent salt-concentrating stack may comprise alternating monovalent anion exchange membranes and monovalent cation exchange membranes.

According to another aspect, there is provided a process for desalinating input saltwater. The input saltwater comprises multivalent ion pairs and the process comprises desalinating the input saltwater using electrodialysis to produce product water and concentrated saltwater; and transferring either multivalent cations or multivalent anions from the concentrated saltwater to other water to generate multivalent anion-rich water and multivalent cation-rich water, wherein the multivalent anion-rich water has a higher concentration of multivalent anions and a lower concentration of multivalent cations than the multivalent cation-rich water, and wherein the transferring is performed using a multivalent cation-extracting stack comprising alternating cation exchange membranes and monovalent anion exchange membranes or a multivalent anion-extracting stack comprising alternating anion exchange membranes and monovalent cation exchange membranes.

The process may further comprise adding monovalent ion species to the input saltwater prior to desalinating the input saltwater using electrodialysis.

The process may further comprise periodically reversing polarity of the multivalent anion-extracting stack or multivalent cation-extracting stack to perform descaling, wherein reversing the polarity of either of the stacks comprises reversing the polarity of an electric field applied across that stack and swapping positions of concentrate and product chambers of that stack.

Reversing the polarity of either of the stacks may further comprise flushing the concentrate chambers of that stack with product water that has exited the product chambers of that stack.

The process may further comprise using one of reverse osmosis, forward osmosis, nanofiltration, electrodialysis, thermal desalination, and membrane distillation to further desalinate the product water.

The process may further comprise generating a precipitate comprising multivalent ion species and a monovalent salt-rich brine by mixing the multivalent cation-rich and multivalent anion-rich waters.

The process may further comprise polishing the monovalent salt-rich brine by precipitating multivalent cations therefrom.

The process may further comprise using an electrodialysis stack (“monovalent salt-concentrating stack”), whose ion exchange membranes comprise alternating monovalent anion exchange membranes and monovalent cation exchange membranes, to concentrate the monovalent salt-rich brine.

The process may further comprise adding the monovalent salt-rich brine, after it has been concentrated by the monovalent salt-concentrating stack, to fresh input saltwater prior to desalinating the fresh input saltwater using electrodialysis.

According to another aspect, there is provided a system for desalinating input saltwater. The input saltwater comprises multivalent ion pairs and the system comprises an electrodialysis subsystem; and a multivalent ion separator subsystem, comprising either (i) a multivalent cation-extracting electrodialysis stack (“multivalent cation-extracting stack”), comprising: alternating cation exchange membranes and monovalent anion exchange membranes; and alternating product chambers and concentrate chambers bounded by the cation exchange membranes and monovalent anion exchange membranes, wherein the multivalent cation-extracting stack removes salts comprising multivalent cations and monovalent anions from its product chambers to its concentrate chambers while desalinating when sufficient voltage is applied across it, and wherein its product chambers are fluidly coupled to the electrodialysis subsystem to receive concentrated saltwater discharged from the electrodialysis subsystem; or (ii) a multivalent anion-extracting electrodialysis stack (“multivalent anion-extracting stack”), comprising: alternating anion exchange membranes and monovalent cation exchange membranes; and alternating product chambers and concentrate chambers bounded by the anion exchange membranes and the monovalent cation exchange membranes, wherein the multivalent anion-extracting stack removes salts comprising multivalent anions and monovalent cations from its product chambers to its concentrate chambers while desalinating when sufficient voltage is applied across it, and wherein its product chambers are fluidly coupled to the electrodialysis subsystem to receive concentrated saltwater discharged from the electrodialysis subsystem.

The input saltwater source may comprise a water tank, and outlets of the product chambers of the multivalent ion separator subsystem may be fluidly coupled to the water tank to form a common fluid circuit comprising the water tank, the concentrate chambers of the electrodialysis stack, and the product chambers of the multivalent ion separator subsystem.

The system may further comprise a multivalent ion tank fluidly coupled to an inlet and outlet of the concentrate chambers of the multivalent ion separator subsystem to form a multivalent ion fluid circuit.

The system may further comprise a monovalent ion species addition subsystem comprising a reserve of at least one of a monovalent salt and a monovalent acid, the monovalent ion species addition subsystem fluidly coupled to the product chambers of the electrodialysis stack to add one or both of the monovalent salt and monovalent acid to the input saltwater.

The system may further comprise a desalination subsystem fluidly coupled to the product chambers of the electrodialysis stack such that product water exiting the product chambers of the electrodialysis stack can be further desalinated, wherein the desalination subsystem comprises one of a reverse osmosis device, a forward osmosis device, a nanofiltration device, an electrodialysis device, a thermal desalination device, and a membrane distillation device.

The system may further comprise a multivalent ion pair salt precipitating subsystem (“salt precipitating subsystem”) fluidly coupled to the concentrate and product chambers of the multivalent ion separator subsystem such that multivalent ions extracted by the multivalent ion separator subsystem can be precipitated and discharged from the system.

The salt precipitating subsystem may output a monovalent ion rich brine, and the system may further comprise a multivalent salt precipitation polishing subsystem (“polishing subsystem”) fluidly coupled to the salt precipitating subsystem to receive the brine and configured to remove multivalent cations therefrom.

The salt precipitating subsystem may output a monovalent ion rich brine, and the system may further comprise a monovalent salt-concentrating electrodialysis stack (“monovalent salt-concentrating stack”) fluidly coupled to the salt precipitating subsystem to receive the brine and configured to concentrate the brine.

The monovalent salt-concentrating stack may be fluidly coupled to the product chambers of the electrodialysis stack and configured to add the brine after it has been concentrated to the input saltwater such that monovalent ion concentration of the input saltwater while in the electrodialysis stack is increased.

The monovalent salt-concentrating stack may comprise alternating monovalent anion exchange membranes and monovalent cation exchange membranes.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a multivalent ion separating parallel desalination system (“MVS-PDS”) comprising two complementary multivalent ion separators, according to one embodiment.

FIG. 2 shows a multivalent cation-extracting electrodialysis stack, used as one of the multivalent ion separators in FIG. 1, in a forward polarity configuration.

FIG. 3 shows the multivalent cation-extracting electrodialysis stack of FIG. 2 in a reverse polarity configuration.

FIG. 4 shows a multivalent anion-extracting electrodialysis stack, used as one of the multivalent ion separators in FIG. 1, in a forward polarity configuration.

FIG. 5 shows the multivalent anion-extracting electrodialysis stack of FIG. 4 in a reverse polarity configuration.

FIG. 6 shows a monovalent salt-concentrating electrodialysis device comprising part of the MVS-PDS of FIG. 1.

FIG. 7 shows a flowchart of a process of desalinating input saltwater using the MVS-PDS of FIG. 1, according to another embodiment.

FIG. 8 shows a flowchart of a multivalent salt extraction process that comprises part of the process of FIG. 7.

FIG. 9 shows a multivalent ion separating series desalination system (“MVS-SDS”) comprising a multivalent ion separator in conjunction with two parallel desalinators, according to another embodiment.

FIG. 10 shows a flowchart for a process of desalinating input saltwater using the MVS-SDS of FIG. 9, according to another embodiment.

FIG. 11 shows a hybrid electrodialysis desalination system with a multivalent ion separator comprising an ED stack in conjunction with a multivalent ion separator (this hybrid system is an “EDR-DS-MVS”), according to another embodiment.

FIG. 12 shows the ED stack used in the system of FIG. 11.

FIG. 13 shows a multi-compartment ED stack that may be used in another embodiment of the EDR-DS-MVS of FIG. 11, in place of the ED stack of FIG. 12.

FIG. 14 shows a flowchart for a process of desalinating input saltwater using the EDR-DS-MVS of FIG. 11, according to another embodiment.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled,” “couples,” and “coupling” as used in this description are intended to include indirect and direct connections unless otherwise indicated. For example, if a first device is coupled to a second device, that coupling may be through a direct connection or through an indirect connection via other devices and connections. Similarly, if the first device is fluidly coupled to the second device, fluid transfer may be through a direct connection or through an indirect connection via other devices and connections.

As used in this disclosure:
1. “Multivalent ion pairs” refers to dissolved and solid salt compounds comprising multivalent cations and multivalent anions.
2. “Monovalent ion species” refers to dissolved and solid salt compounds comprising monovalent cations and monovalent anions.
3. “Monovalent cation exchange membrane” refers to a cation exchange membrane substantially permeable to monovalent cations, less permeable to multivalent cations, and substantially impermeable to anions (whether multivalent or monovalent). “Substantially permeable” refers to the permeability ratio of monovalent cations to multivalent cations being greater than 1, and preferably being greater than 10.
4. “Monovalent anion exchange membrane” refers to an anion exchange membrane substantially permeable to monovalent anions, less permeable multivalent anions, and substantially impermeable to cations (whether multivalent or monovalent). “Substantially permeable” refers to the permeability ratio of monovalent anions to multivalent anions being greater than 1, and preferably being greater than 10.
5. “Recovery,” as used in association with a desalination process and system, refers to the ratio of desalinated water leaving that process and system relative to the saltwater input to that process and system, respectively.
6. “Desalinating” water refers to removing monovalent or multivalent ions from that water.
7. As used in the FIGS.:
   (a) “l⁺” refers to monovalent cations.
   (b) “l⁻” refers to monovalent anions.
   (c) “M⁺” refers to multivalent cations.
   (d) “M⁻” refers to multivalent anions.
   (e) “E” refers to an electrolyte solution.
   (f) “R” refers to a rinse solution.
   (g) “C^{M+}” refers to a saltwater solution in which the highest multivalent ion concentration is cationic.
   (h) “P^{M-}” refers to a saltwater solution in which the highest multivalent ion concentration is anionic.

Embodiments described herein are directed to a desalination system and process to desalinate saltwater such as industrial saltwater and inland brackish water. The saltwater to be desalinated is referred to as “input saltwater”, which is typically rich in sparingly soluble multivalent ion pairs such as CaSO₄, Ca₃(PO₄)₂ and CaCO₃, and which may scale desalination equipment. The input saltwater may be poor in monovalent ion species. A monovalent ion species addition subsystem may optionally add one or more monovalent salts, such as NaCl, and one or more monovalent acids, such as HCl, to the input saltwater. As discussed in further detail below, the level of monovalent salt or monovalent acid in the input saltwater should be sufficiently high to permit an ionic current to be conducted, which allows the multivalent ion separator to split sparingly soluble multivalent ion pairs into highly soluble salts comprising i) multivalent cations and monovalent anions and ii) monovalent cations and multivalent anions. A monovalent ion species recovery subsystem may also optionally comprise part of the desalination system in order to recover monovalent ions.

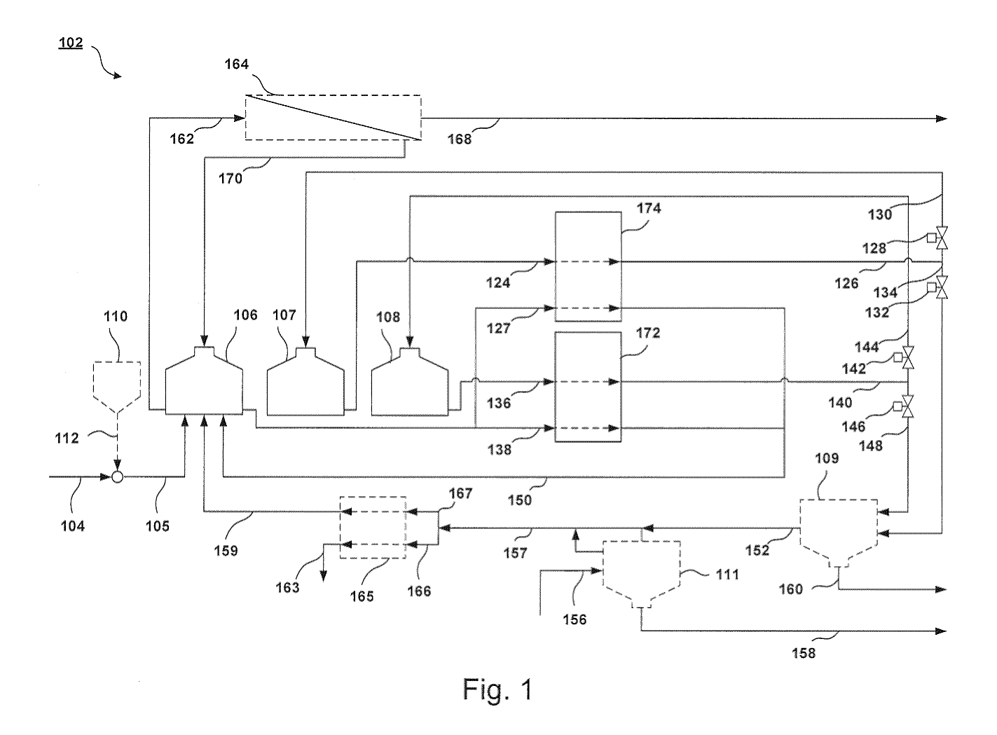

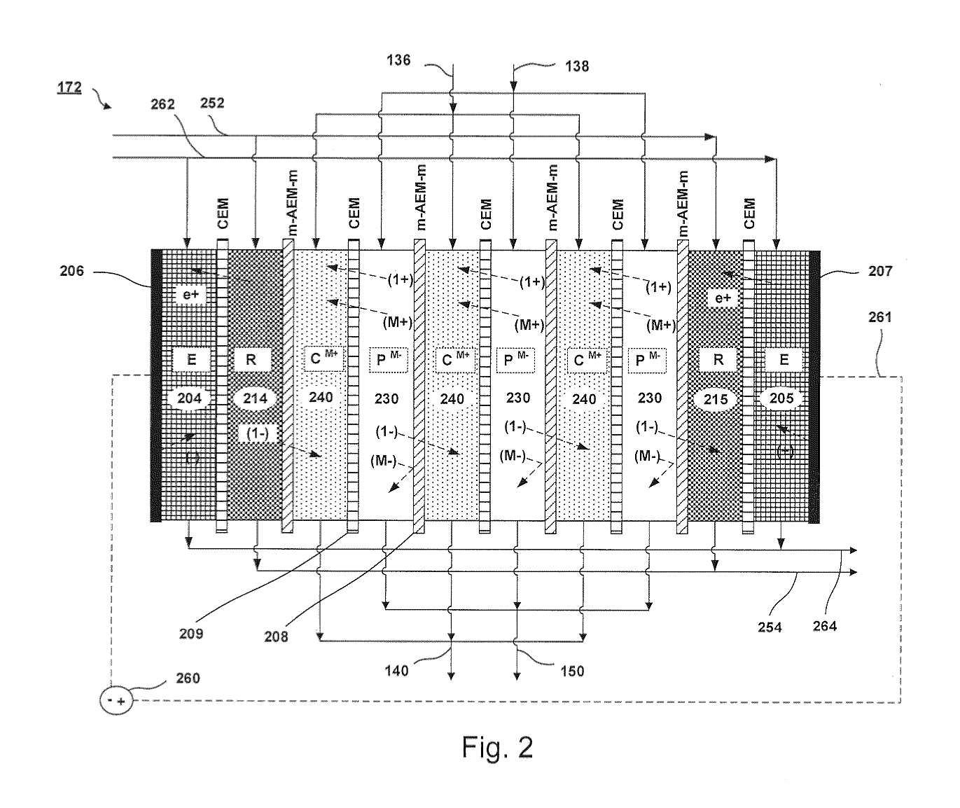

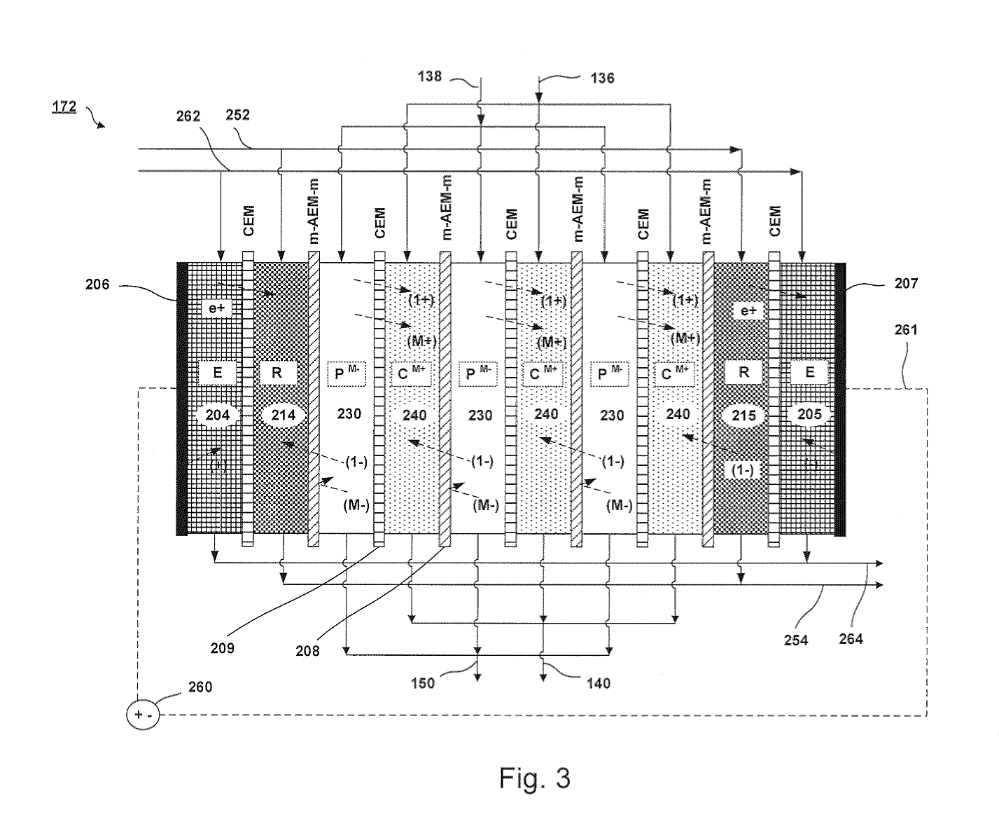

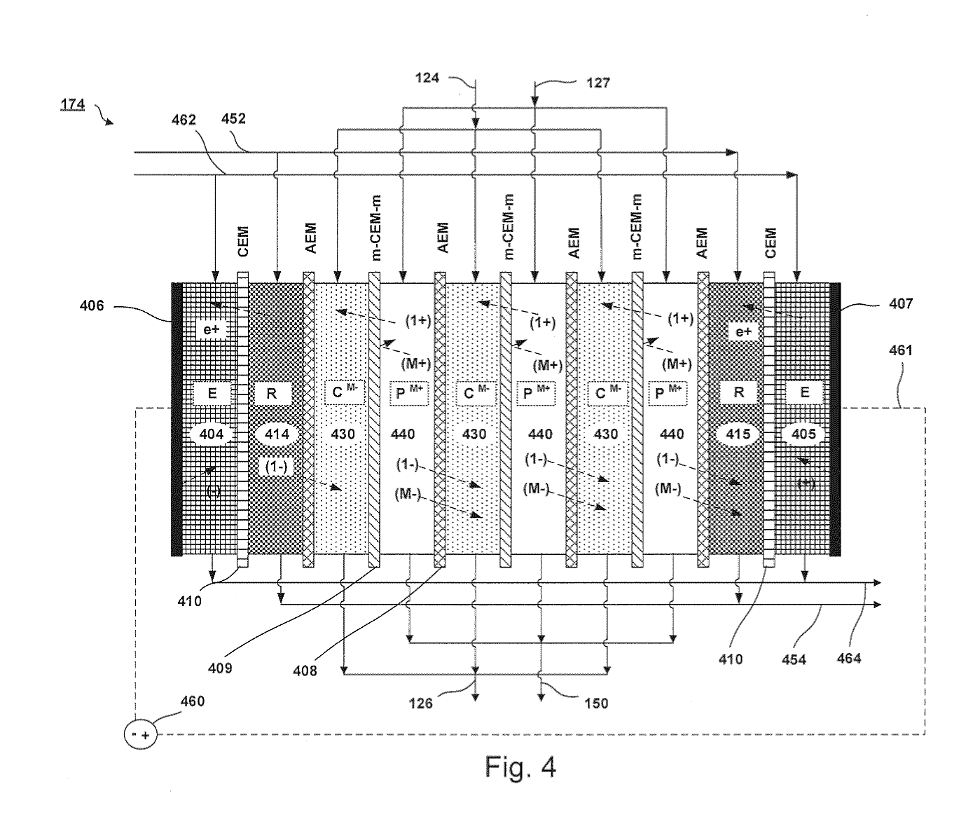

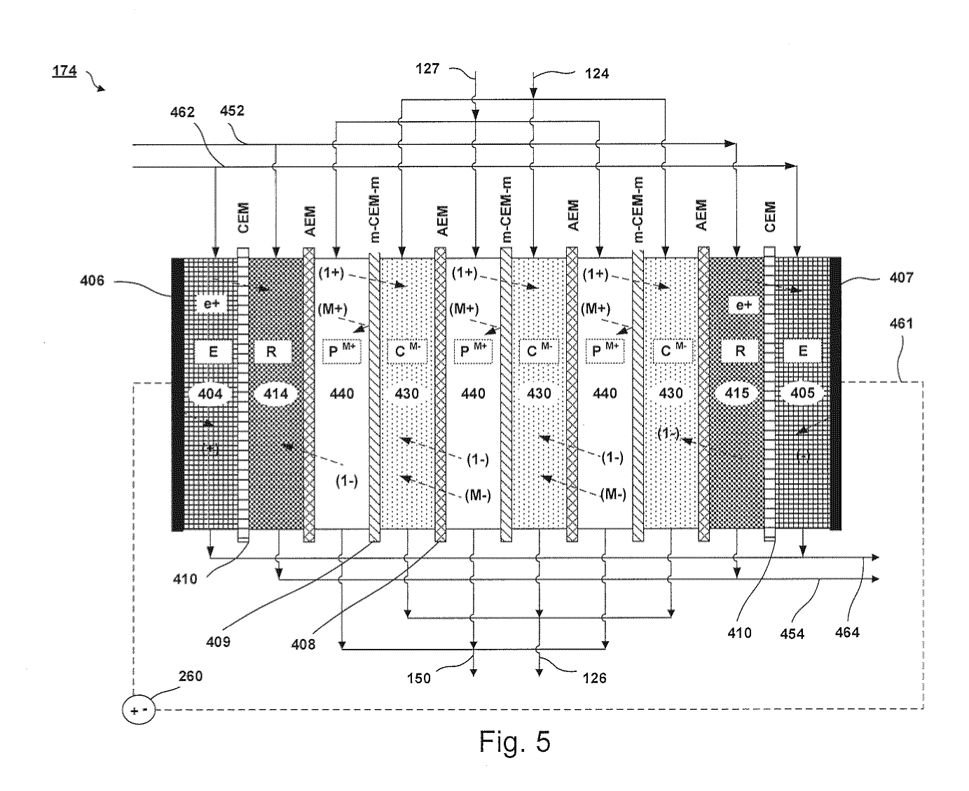

FIG. 1 shows a schematic diagram of a multivalent ion separating parallel desalination system (“MVS-PDS”) 102, according to one embodiment. The MVS-PDS 102 comprises two complementary multivalent ion separators 172,174 (each an “MVS”) used to desalinate the input saltwater so that the concentrations of the multivalent ion pairs in the resulting desalinated water exiting the separators 172,174 are within their solubility limits (desalinated water or partially desalinated water is hereinafter referred to interchangeably as “product water”). The MVSs 172,174 operate in parallel: one of the MVSs 172 is a multivalent cation-extracting electrodialysis stack comprising alternating cation exchange membranes and monovalent anion exchange membranes (this MVS 172 is hereinafter the “multivalent cation-extracting stack 172”), and the other of the MVSs 174 is a multivalent anion-extracting electrodialysis stack comprising alternating anion exchange membranes and monovalent cation exchange membranes (this MVS 174 is hereinafter the “multivalent anion-extracting stack 174”). Optionally, the MVS-PDS 102 also comprises any one or more of a multivalent ion pair salt precipitating subsystem (hereinafter the “salt precipitating subsystem”) 109, a monovalent ion species addition subsystem 110, a multivalent salt precipitation polishing subsystem (hereinafter the “polishing subsystem”) 111, a desalination subsystem 164 such as an RO subsystem, and a monovalent salt-concentrating electrodialysis stack (hereinafter the “monovalent salt-concentrating stack”) 165. The multivalent cation-extracting stack 172 is described in more detail in FIGS. 2 and 3 below, and the multivalent anion-extracting stack 174 is described in more detail in FIGS. 4 and 5 below. The term “complementary” is employed here to refer to the fact that the two stacks 172,174 separately remove the counter-ions of the multivalent ion pairs of concern in the MVS-PDS 102.

The input saltwater is supplied to a main tank 106 that comprises part of the MVS-PDS 102 via an input conduit 104. The main tank 106 is fluidly coupled to the multivalent cation-extracting stack 172 and to the multivalent anion-extracting stack 174 via a pair of feed water conduits 138,127, and feed water for desalination is pumped to the stacks 172,174 via these conduits 138,127. The input saltwater may be poor in monovalent ion species. If present, the monovalent ion species addition subsystem 110 may add one or more monovalent salts, such as sodium chloride, and one or more monovalent acids, such as hydrochloric acid, to the input saltwater via a monovalent ion addition conduit 112. The quantity of monovalent salt or monovalent acid added is selected to permit ionic current to flow through the ion exchange membranes of the stacks 172,174, as described in more detail below. The MVS-PDS 102 splits salts comprising multivalent cations and multivalent anions and recombines the resulting multivalent ions with monovalent counter-ions to produce salts that result in much less or no scaling.

The multivalent cation-extracting stack 172 removes salts comprising multivalent cations and monovalent anions from the feed water and outputs a multivalent cation-rich water along a first output conduit 140, which is fluidly coupled to a multivalent cation tank 108 via a conduit 144 and a valve 142. The multivalent anion-extracting stack 174 analogously removes salts comprising multivalent anions and monovalent cations from the feed water and outputs a multivalent anion-rich water along a first output conduit 126, which is fluidly coupled to a multivalent anion tank 107 via a conduit 130 and a valve 128. The multivalent cation-poor water, which is relatively rich in multivalent anions, output from the multivalent cation-extracting stack 172 and the multivalent anion-poor water, which is relatively rich in multivalent cations, output from the multivalent anion-extracting stack 174 are recirculated through a common output conduit 150 back to the main tank 106 and back to the stacks 172,174 as feed water until the concentration of multivalent cations and multivalent anions in the tank 106 are at a desired concentration. The MVS-PDS 102 may further comprise a supplemental desalinator device such as a desalination subsystem 164 to polish or to more effectively desalinate the water from the tank 106 after the stacks 172,174 have removed multivalent ion pairs such that the concentration of these pairs is low enough that they do not pose an unacceptable scaling danger to the desalination subsystem 164 due to their low solubility limits. That is, the stacks 172,174 may be operated to reduce the concentration of the scaling multivalent ion pairs to below the solubility limit of the scaling salts comprising those pairs. In order to increase recovery, the multivalent anion salts in the multivalent anion tank 107 and the complementary multivalent cation salts in the multivalent cation tank 108 may be both maintained well below their solubility limits at the MVS-PSD's 102 operating temperature, and then optionally supplied to the salt precipitating subsystem 109, producing precipitates of non-soluble species, which may be solids such as CaSO₄. Those precipitates may be discharged from the MVS-PDS 102 via an output conduit 160. Alternatively, the multivalent anion salts in the multivalent anion tank 107 and the complementary multivalent cation salts in the multivalent cation tank 108 may be recovered for other industrial uses or be discharged directly from the MVS-PDS 102.

The reaction in the salt precipitating subsystem 109 also produces a brine that is output along a conduit 152. In embodiments in which the polishing subsystem 111 is present, the polishing subsystem 111 is fluidly coupled to the salt precipitating subsystem 109 along the conduit 152 and provides additional polishing to remove or recover multivalent cations that remain in the brine. One or more precipitation agents, such as sodium hydroxide, sodium carbonate, calcium hydroxide and their combinations, may be added through an input conduit 156 and the precipitate rich product may be removed from the polishing subsystem 111 via an output conduit 158.

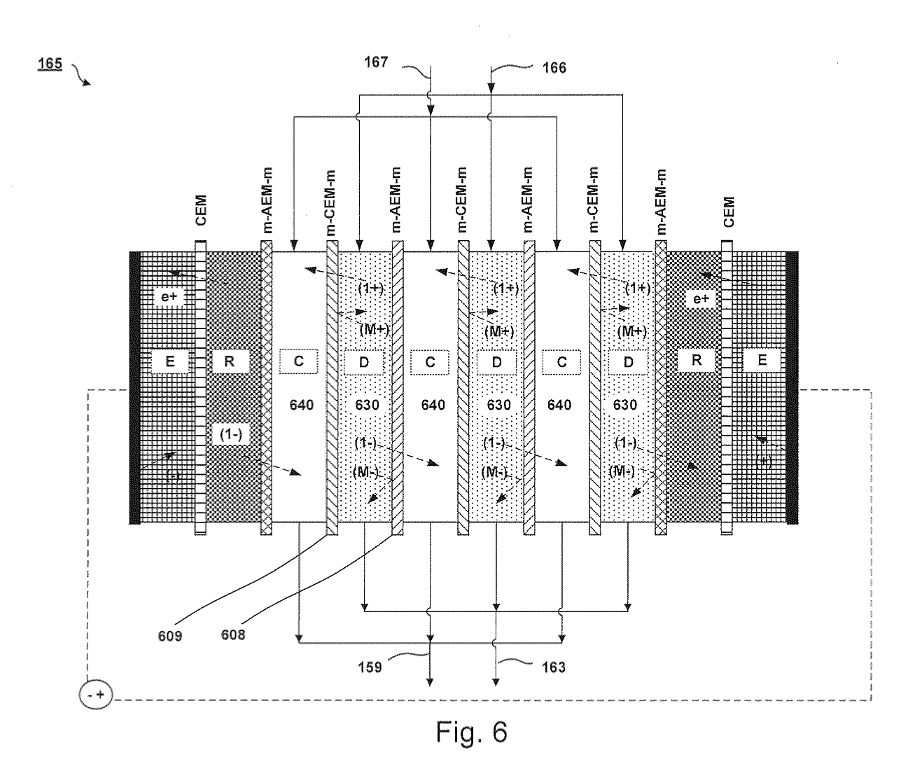

The monovalent ion species entering the multivalent cation-extracting and anion-extracting stacks 172,174 and the salt precipitating subsystem 109 may optionally be recirculated through a conduit 159 to the main tank 106 when the input saltwater is poor in monovalent ion species, or be removed from the MVS-PDS 102 through the output conduit 160 when the input saltwater is rich in monovalent ion species. When the monovalent salt-rich brine is recirculated to the main tank 106, it may be recirculated via the monovalent salt-concentrating stack 165, which further concentrates that brine and which is described in more detail in FIG. 6 below.

After having passed through the stacks 172,174, the product water in the main tank 106 may be discharged from the MVS-PDS 102 through conduit 168 or may be further polished or desalinated before discharge by the desalination subsystem 164. The desalination subsystem 164 produces desalinated permeate that is discharged from MVS-PDS 102 through a discharge conduit 168. The concentrated brine rejected through the desalination subsystem 164 is returned to the main tank 106 and mixed there with the input saltwater for further treatment in the MVS-PDS 102. While in one example embodiment the desalination subsystem 164 is an RO subsystem, in alternative embodiments the desalination subsystem 164 may be any of an electrodialysis desalinator device, a forward osmosis device, a nanofiltration desalinator device, a membrane distillation desalinator device, and a thermal evaporation desalinator device, or any suitable combination of two or more of the foregoing desalinator devices.

The multivalent cation-extracting and anion-extracting stacks 172,174 in FIG. 1 are shown arranged in parallel, but in an alternative embodiment they may be arranged in series.

FIGS. 2 and 3 show schematics of the multivalent cation-extracting stack 172. FIG. 2 shows the stack 172 operating in forward polarity, while FIG. 3 shows the stack 172 operating in reverse polarity. The feed water from the main tank 106 in FIG. 1 is supplied to the multivalent cation-extracting stack 172 and its product chambers (hereinafter interchangeably referred to as “P-chambers”) 230 through the feed water conduit 138. A concentrate stream from the multivalent cation tank 108 in FIG. 1 is supplied to the multivalent cation-extracting stack 172 and its concentrate chambers (hereinafter interchangeably referred to as “C-chambers”) 240 through a concentrate input conduit 136. Fluid exits the C-chambers 240 via the first output conduit 140 and exits the P-chambers 230 via the common output conduit 150. In the multivalent cation-extracting stack 172, the chambers 230,240 are separated by ion exchange membranes. There are two types of ion exchange membranes in the stack 172 arranged in alternating sequence. The first type of ion exchange membrane is a cation exchange membrane (“CEM”) 209. The CEM 209 is more permeable to multivalent cations than to monovalent cations and is impermeable to anions. The second type of ion exchange membrane is a monovalent anion exchange membrane (“m-AEM-m”) 208, which is permeable to monovalent anions and substantially less permeable to multivalent anions. It is impermeable to cations. Suitable cation exchange membranes 209 include the Astom CMX™ membrane. Suitable monovalent anion exchange membranes 208 include the Astom ACS™ membrane.

On each end of the multivalent cation-extracting stack 172 are electrolyte chambers 204,205: in the forward polarity mode, a first electrolyte chamber 204 is on the left-hand side of FIG. 2 (the cathode side) and a second electrolyte chamber 205 is on the right-hand side of FIG. 2 (the anode side). An electrolyte solution is contained in an electrolyte tank (not shown) and pumped by electrolyte pump (not shown) through an electrolyte distribution conduit 262 into the electrolyte chambers 204,205 in parallel. The electrolyte solution flows back into the electrolyte tank in a closed loop process via an electrolyte return conduit 264. In an alternative embodiment (not shown), a series closed loop circuit may be used where the electrolyte solution flows in one direction through the second electrolyte chamber 205 and in the opposite direction through the first electrolyte chamber 204. Example electrolytes may include aqueous sodium sulfate and aqueous potassium nitrate.

Adjacent to each of the electrolyte chambers 204,205, and separated from them by a cation exchange membrane 209, are first and second rinse solution chambers 214,215. While the stack 172 of FIG. 2 includes the rinse solution chambers 214,215, the rinse solution chambers 214,215 may be absent from alternative embodiments (not shown). In the embodiment shown in FIG. 2 the rinse solution chambers 214,215 are separated from the P-chambers 230 and C-chambers 240 by a monovalent anion exchange membrane 208. In an alternative embodiment, the rinse solution chambers 214,215 may be separated from the P-chambers 230 and C-chambers 240 by an anion exchange membrane such as an Astom AMX™ membrane. The rinse solution chambers 214,215 protect the electrolyte chambers 204,205 from pollution by divalent scaling ions such as Ca²⁺ and Mg²⁺. A rinse solution is supplied via a conduit 252 and may comprise conductive but non-scaling aqueous salts such as sodium chloride. The rinse solution is removed from the rinse solution chambers 214,215 via a rinse solution return conduit 254.

A direct current power supply 260 applies an electric potential (voltage) across the electrodes 206,207 at the ends of the multivalent cation-extracting stack 172, thereby causing an electric current 261 to flow between the electrodes 206,207. When operated in forward polarity, the electrode 207 on the right-hand side of FIG. 2 becomes the positively charged anode toward which anions flow and the electrode 206 on the left-hand side of FIG. 2 becomes the negatively charged cathode to which cations flow. Reduction and oxidation reactions of the electrolyte occur at the cathode and anode respectively, converting the DC electrical current into an ionic current comprising moving anions and cations. More particularly, the electric potential moves the monovalent anions through the monovalent anion exchange membranes 208, but most of the multivalent anions, and all the cations, are stopped by the monovalent anion exchange membranes 208. The electric potential forces the multivalent cations and some monovalent cations through the cation exchange membranes 209, but the cation exchange membranes 209 substantially stop all anions. The result of this preferential transit of multivalent cations through the cation exchange membranes 209 is that the concentration of multivalent cations increases in the C-chambers 240 and the concentration of multivalent cations decreases in the P-chambers 230.

The multivalent cation-rich water in the C-chambers 240 is then routed as output concentrate on the first output conduit 140 and back to the multivalent cation tank 108 and the multivalent cation-poor water of the P-chambers 230 is routed as product water on the common output conduit 150 and back to the main tank 106, as described in respect of FIG. 1. The water in the main tank 106, including water which has already passed through one or both of the stacks 172,174 one or more times, is recirculated back to the multivalent cation-extracting stack 172 until the multivalent cation concentration of that water is reduced to the desired limit. The multivalent cation-poor water in the P-chambers 230 is relatively rich in multivalent anions.

The routing of the contents of the chambers 230,240 may be controlled via suitable valve, conduit, and pump subsystems. For the sake of clarity, these are not shown in FIG. 1 or 2.

Turning now to FIG. 3, there is shown the multivalent cation-extracting stack 172 operating in reverse polarity; that is, the polarity of the power supply 260 is reversed relative to its polarity in FIG. 2. In reverse polarity the electrode 207 on the right-hand side of FIG. 3 becomes the negatively charged cathode toward which cations flow and the electrode 206 on the left-hand side of FIG. 3 becomes the positively charged anode to which anions flow. Relative to the stack 172 as shown in FIG. 2, the P-chambers 230 and C-chambers 240 swap positions. More particularly, the electric potential forces the monovalent anions through the monovalent anion exchange membranes 208, but most of the multivalent anions, and all of the cations, are stopped by the monovalent anion exchange membranes 208. The electric potential forces both multivalent cations and some monovalent cations through the cation exchange membranes 209, but the cation exchange membranes 209 substantially stop all anions. The result of this preferential transit of multivalent cations through the cation exchange membranes 209 is that the concentration of multivalent cations increases in the C-chambers 240 and decreases in the P-chambers 230.

The multivalent cation-rich water in the C-chambers 240 is then routed as output concentrate on the first output conduit 140 and back to the multivalent cation tank 108 and the multivalent cation-poor water of the P-chambers 230 is routed as product water on the common output conduit 150 and back to the main tank 106. The water in the main tank 106, including water which has already passed through one or both of the stacks 172,174 one or more times, is recirculated back to the multivalent cation-extracting stack 172 until the multivalent cation concentration of that water is reduced to the desired limit. The multivalent cation-poor water in the P-chambers 230 is relatively rich in multivalent anions.

As scaling constituents are present in the input saltwater, the ion exchange membranes 208,209 in the multivalent cation-extracting stack 172 may accumulate scalants on their surfaces, which would prejudice the system's 102 desalination efficiency. Scale built up on the ion exchange membranes 208,209 is evidenced during operation by an increase in resistance to the electric current 261. Once the electrical resistance has reached a level indicative of significant scaling being present on the ion exchange membranes 208,209, the stack polarity is switched; for example, if the multivalent cation-extracting stack 172 accumulates scaling while operating in forward polarity as shown in FIG. 2, switching polarity entails operating the stack 172 in reverse polarity as shown in FIG. 3. The reverse flow of ions through the ion exchange membranes 208,209 and swapping the positions of the P-chambers 230 and C-chambers 240 when operating in reverse polarity effectively removes scale built up while operating in forward polarity. The multivalent cation-extracting stack 172 may be operated cyclically between forward and reverse polarities to continuously remove scale built up on the ion exchange membranes 208,209. When switching between forward and reverse polarities, the multivalent cation-extracting stack 172 may undergo a “flush sequence”. When switching from forward polarity to reverse polarity or from reverse polarity to forward polarity, performing the flush sequence comprises flushing the fluid in the C-chambers 240 and associated conduits using product water that has exited the P-chambers 230, such as product water from the main tank 106. This product water and residual concentrate in the C-chambers 240 mix, and this mixture is either output to the multivalent cation tank 108 or directly to the salt precipitating subsystem 109.

FIGS. 4 and 5 show the multivalent anion-extracting electrodialysis stack 174. FIG. 4 describes the multivalent anion-extracting stack 174 when it is operating in forward polarity while FIG. 5 describes the multivalent anion-extracting stack 174 when it is operating in reverse polarity.

The feed water from the main tank 106 in FIG. 1 is supplied to the multivalent anion-extracting stack 174 and its product chambers (hereinafter interchangeably referred to as “P-chambers”) 440 through the feed water conduit 127. The concentrate stream from the multivalent anion tank 107 is supplied to the multivalent anion-extracting stack 174 and its concentrate chambers (hereinafter interchangeably referred to as “C-chambers”) 430 through the concentrate input conduit 124. The fluid in the C-chambers 430 exits those chambers 430 via the first output conduit 126, and the fluid in the P-chambers 440 exits those chambers 440 via the common output conduit 150.

In the multivalent anion-extracting stack 174 shown in FIG. 4, the electrode 406 on the left-hand side of FIG. 4 is the negatively charged cathode and the electrode 407 on the right-hand side of FIG. 4 is the positively charged anode. The required voltage is supplied by the direct current power supply 460. The chambers 430,440 are separated by alternating monovalent cation exchange membranes (each an “m-CEM-m”) 409 and anion exchange membranes (each an “AEM”) 408. The anion exchange membranes 408 are more permeable to multivalent anions than to monovalent anions, but are impermeable to cations. The monovalent cation exchange membranes are permeable to monovalent cations, but substantially less permeable to multivalent cations; they are impermeable to anions. Suitable anion exchange membranes 408 include Astom AMX™ membranes. Suitable monovalent cation exchange membranes 409 include Astom CMS™ membranes. In this embodiment the ion exchange membranes separating the optional rinse solution chambers 414,415 from the P-chambers 440 and C-chambers 430 are two of the anion exchange membranes 408. In alternative embodiments (not shown), the ion exchange membranes separating the rinse solution chambers 414,415 from the P-chambers 440 and C-chambers 430 may be monovalent anion exchange membranes. As with the embodiment of FIGS. 2 and 3, the electrolyte chambers 404,405 are separated from the rinse solution chambers 414,415 by two of the cation exchange membranes 410. Electrolyte is supplied to the electrolyte chambers 404,405 in parallel via a conduit 462 and electrolyte solution flows back into in a closed loop process via an electrolyte return conduit 464. Rinse solution is supplied via a conduit 452 to the rinse solution chambers 414,415 and is removed from the rinse solution chambers 414,415 via a rinse solution return conduit 454.

When operating in forward polarity as shown in FIG. 4, monovalent cations are forced through the monovalent cationic exchange membranes 409 by the electric potential, while multivalent cations are comparatively slow to permeate those membranes 409. All anions are blocked by the monovalent cationic exchange membranes 409. The electric potential forces both monovalent and multivalent anions through the anion exchange membranes 408, but those membranes 408 block all cations. The result of this preferential transit of multivalent anions through the anionic exchange membranes 408 is that the concentration of multivalent anions increases in the C-chambers 430 and decreases in the P-chambers 440.

The multivalent anion-rich water in the C-chambers 430 is routed as output concentrate to the multivalent anion tank 107 via the first output conduit 126. The multivalent anion-poor water in the P-chambers 440 is routed as output product water to the main tank 106 via the common output conduit 150. The output product water is recirculated to the stack 174 until the concentration of multivalent anions of the product water in the main tank 106 is reduced to the desired limit. Multivalent anion-poor product water from the multivalent anion-extracting stack 174 is relatively rich in multivalent cations.

The routing of the contents of the chambers 430,440 may be controlled via suitable valve, conduit, and pump subsystems. For the sake of clarity, these are not shown in FIG. 4 or 5. This is similarly true of any recirculation of operating fluids through the multivalent anion-extracting stack 174.

FIG. 5 shows the same multivalent anion-extracting stack 174 of FIG. 4, but operating in reverse polarity as indicated by the polarity of the power source 260. In this configuration, the positions of the P-chambers 440 and C-chambers 430 are swapped relative to when the stack 174 is operating in forward polarity. Accordingly, the applied electric potential causes multivalent anions to concentrate in the C-chambers 430 and to have their concentration reduced in the P-chambers 440. In order to perform descaling, the multivalent anion-extracting stack 174 may switch between forward and reverse polarities and have its concentrate chambers 430 flushed using product water from the main tank 106 in a manner analogous to that described above in respect of the multivalent cation-extracting tank 172. When the concentrate chambers 430 of the multivalent anion-extracting tank 172 are flushed, the mixed product water and concentrate may be output to one or both of the multivalent anion tank 107 or the salt precipitating subsystem 109.

FIG. 6 is a schematic of the monovalent salt-concentrating stack 165. It employs the same arrangement of electrodes, optional rinse chambers, and electrolyte chambers as already described in respect of the multivalent cation-extracting stack 172 of FIGS. 2 and 3. Between the rinse chambers, the monovalent salt-concentrating stack 165 comprises an alternating series of monovalent anion exchange membranes 608 and monovalent cation exchange membranes 609, which define an alternating series of C-chambers 640 and diluent chambers (hereinafter interchangeably referred to as “D-chambers”) 630. The monovalent cation exchange membranes 609 and monovalent anion exchange membranes 608 in the monovalent salt-concentrating stack 165 operate together to concentrate monovalent ions in the saltwater from one or both of the salt precipitating subsystem 109 and the polishing subsystem 111 in the C-chambers 640. Whatever few multivalent ions remain in the water from the subsystems 109,111 are confined to the D-chambers 630. The monovalent saltwater in the conduit 157 that receives the output of the subsystems 109,111 is routed to a C-input conduit 167 and to a D-input conduit 166. The concentrated monovalent saltwater from the C-chambers 640 is routed through one of the conduits 159 to the main tank 106, while the water from which the monovalent salts have been depleted is in the D-chambers 630 is discharged through another of the conduits 163. In an alternative embodiment (not shown), the C-input conduit 167 and the C-output conduit 159 may be coupled with the common output conduit 150 so that the product water in the common output conduit 150 is used as feed water for the C-chambers 640. The monovalent salt-concentrating stack 165 may be operated in forward or reverse polarities in a manner analogous to the multivalent cation-extracting stack 172 to remove any membrane scalants that accumulate during operation.

As may be seen from the above, the electrodialysis process in the multivalent cation-extracting stack 172 and the electrodialysis process in multivalent anion-extracting stack 174 are mutually complementary in that they separately extract the multivalent cations and multivalent anions, respectively.

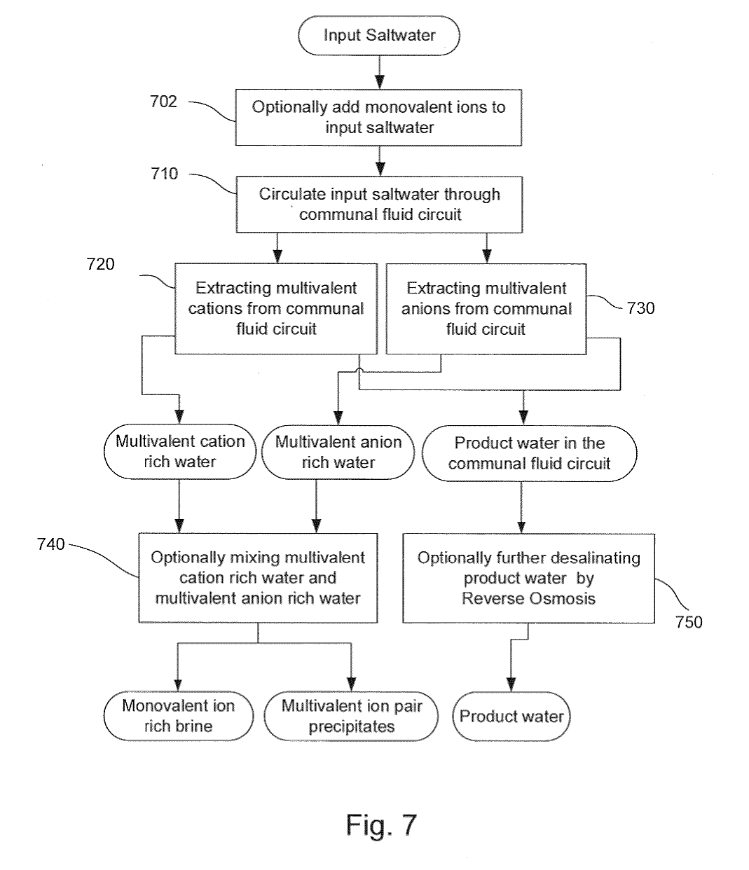

Referring to FIG. 7, there is shown a flowchart of a process for desalinating the input saltwater by extracting multivalent cations and multivalent anions separately from the input saltwater into independent multivalent cation and multivalent anion fluid circuits; in one embodiment, the MVS-PDS 102 may be used to perform this process. The product water may then further be desalinated by the desalination subsystem 164, which as mentioned above may comprise RO devices, electrodialysis devices, nanofiltration devices, membrane distillation devices, and thermal evaporation devices. The multivalent anion-rich water and the multivalent cation-rich water may then be mixed to extract deleterious multivalent ion pairs that can otherwise cause scaling. The input water is recirculated through a common fluid circuit to ensure that both multivalent cations and multivalent anions are extracted. In more detail, the process comprises:
(a) circulating the input saltwater [710] through the common fluid circuit, which in the MVS-PDS 102 comprises the main tank 106, the feed water conduits 127,138, the P-chambers 230 in the multivalent cation-extracting stack 172, the P-chambers 440 in the multivalent anion-extracting stack 174, and the common output conduit 150, which the two stacks 172,174 share;
(b) removing multivalent cations [720] from the input saltwater (which, when the process is performed using the MVS-PDS 102, is done using the multivalent cation-extracting stack 172) and transferring them to a multivalent cation-rich fluid circuit, which in the MVS-PDS 102 comprises the concentrate input conduit 136, the C-chambers 240 in the multivalent cation-extracting stack 172, the first output conduit 140, the multivalent cation tank 108, and the valve 142 and conduit 144 that fluidly couple the first output conduit 140 to the multivalent cation tank 108;
(c) removing multivalent anions [730] from the input saltwater (which, when the process is performed using the MVS-PDS 102, is done using the multivalent anion-extracting stack 174) and transferring them to a multivalent anion-rich fluid circuit, which in the MVS-PDS 102 comprises the concentrate input conduit 124, the C-chambers 430 in the multivalent anion-extracting stack, the conduit 420, the first output conduit 126, the multivalent anion tank 107, and the valve 128 and conduit 130 that fluidly couple the first output conduit 140 to the multivalent anion tank 107;
(d) optionally adding [702] monovalent ion species to the input saltwater, which when performed using the MVS-PDS 102 is done by the monovalent ion species addition subsystem 110 via the monovalent ion addition conduit 112;
(e) optionally mixing [740] saltwater from the multivalent cation-rich fluid circuit and from the multivalent anion-rich fluid circuit to produce multivalent ion pair precipitates and monovalent ion rich brine, which when performed using the MVS-PDS 102 is performed using the salt precipitating subsystem 109; and
(f) optionally further desalinating [750] the product water in the common fluid circuit, which when performed using the MVS-PDS 102 is performed by the desalination subsystem 164 and which results in the product water being output along the discharge conduit 168.

The process of FIG. 7 may further comprise reversing, periodically, the polarity of one or both of the stacks 172,174 to descale any scalants that have accumulated on the stacks' 172,174 ion exchange membranes.

When the process of FIG. 7 is implemented using the MVS-PDS 102, removing multivalent cations from the input saltwater is performed in a multivalent cation-extracting branch of the common fluid circuit. The cation-extracting branch in FIG. 1 comprises the feed water conduit 138, the P-chambers 230 in the multivalent cation-extracting stack 172, and the common output conduit 150. Analogously, when the process of FIG. 7 is implemented using the MVS-PDS 102, removing multivalent anions from the input saltwater is performed in a multivalent anion-extracting branch of the common fluid circuit. The anion-extracting branch in FIG. 1 comprises the feed water conduit 127, the P-chambers 440 in the multivalent anion-extracting stack 174, and the common output conduit 150. More specifically, removing the multivalent cations and multivalent anions from the input saltwater is done in the multivalent cation-extracting stack 172 and the multivalent anion-extracting stack 174, respectively, which are in portions of the cation-extracting branch and anion-extracting branch that are distinct from each other.

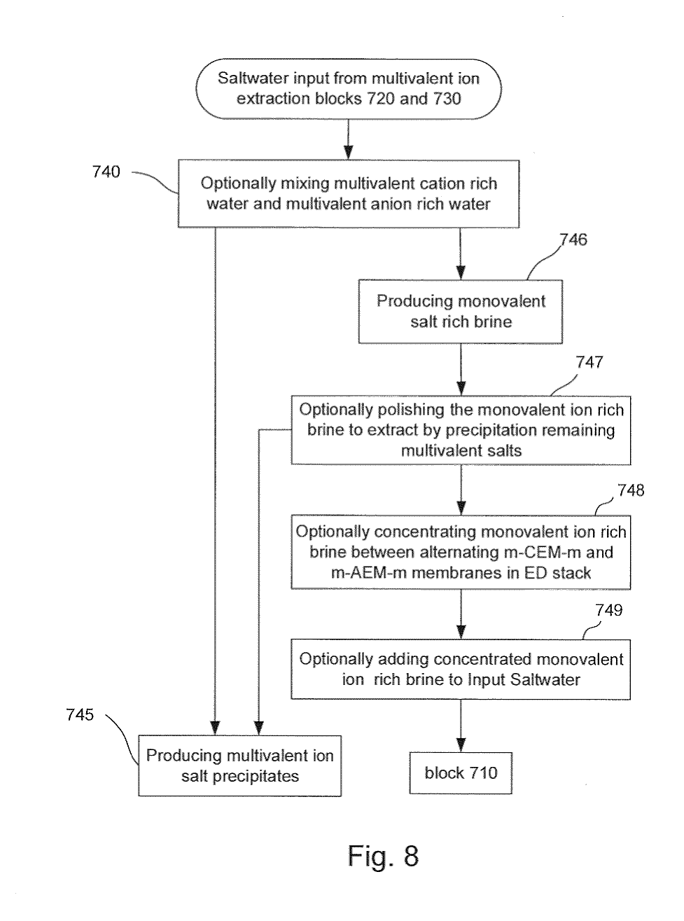

As shown in FIG. 8, optionally mixing [740] multivalent cation-rich water and multivalent anion-rich water from the multivalent cation-rich fluid circuit and multivalent anion-rich fluid circuit, respectively, may produce [745] multivalent ion salt precipitate and a monovalent ion rich brine [746]. When this precipitate and brine are produced using the MVS-PDS 102, the precipitate is discharged on the output conduit 160 and the brine is output on another conduit 152. The monovalent ion rich brine may optionally be polished [747] by, for example, precipitating further multivalent salts, which when using the MVS-PDS 102 is done in the polishing subsystem 111.

The process may further comprise concentrating [748] monovalent ions (in the monovalent ion rich brine) in the monovalent salt-concentrating stack 165, as described above in respect of FIG. 6.

The concentrated monovalent ion rich brine may be output on the conduit 159 to the main tank 106. The process may accordingly further comprise adding [749] the concentrated monovalent ion rich brine to the input saltwater (such as, for example, at the tank 106) for recirculating as per the foregoing process.

As part of this system and process using the MVS-PDS 102, the multivalent cation-extracting stack 172 outputs multivalent cation-rich water to the first output conduit 140 and multivalent cation-poor water to the common output conduit 150. The multivalent anion-extracting stack 174, in turn, outputs multivalent anion-rich water to the first output conduit 126 and multivalent anion-poor water on the common output conduit 150. The multivalent cation-poor water is relatively rich in multivalent anions and the multivalent anion-poor water is relatively rich in multivalent cations. The multivalent cation-poor water in the common output conduit 150 is circulated via the main tank 106 to both the multivalent cation-extracting and anion-extracting stacks 172,174, re-entering them via the feed water conduits 138,127. The multivalent cation-poor water that the multivalent cation-extracting stack 172 outputs thereby has the multivalent anions removed from it by the multivalent anion-extracting stack 174, and the multivalent anion-poor water that the multivalent anion-extracting stack 174 outputs thereby has the multivalent cations removed from it by the multivalent cation-extracting stack 172. This pattern of flow comprises part of the common fluid circuit, which, as water recirculates in it, continues to remove both kinds of multivalent ions. The same is not true for the multivalent cation-rich water output from the multivalent cation-extracting stack 172 and the multivalent anion-rich water output from the multivalent anion-extracting stack 174. These remain in the multivalent cation-rich fluid circuit and the multivalent anion-rich fluid circuit, respectively, which are distinct from each other and which allow the two multivalent ion concentrations to build up separately as circulation continues.

The multivalent cation-extracting and anion-extracting stacks 172,174 preferentially remove multivalent ion species as long as they are present in significant concentrations. However, when those concentrations are reduced, they will also remove monovalent ion species from the common fluid circuit. Therefore, the desalination subsystem 164, while optional for removing monovalent ion species, may be used to improve the efficiency of the MVS-PDS 102 in industrial settings.

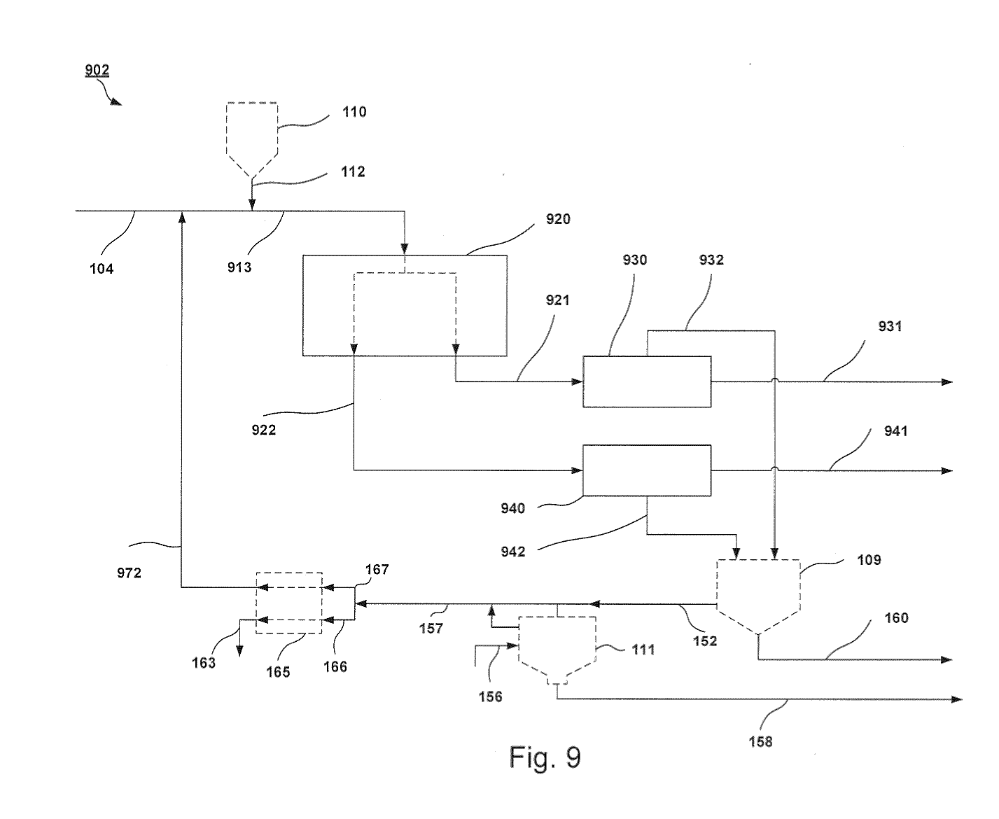

FIG. 9 shows a schematic of a multivalent ion separating series desalination system (“MVS-SDS”) 902, according to another embodiment. The MVS-SDS 902 comprises (a) a multivalent ion separator subsystem (“MVS subsystem”) 920; and (b) a first desalinator subsystem 930 and a second desalinator subsystem 940, wherein the MVS subsystem 920 is arranged (i) to provide multivalent cation-rich water to the first desalinator subsystem 930 and multivalent cation-poor water to the second desalinator subsystem 940, or (ii) to provide a multivalent anion-rich water to the first desalinator subsystem 930 and multivalent anion-poor water to the second desalinator subsystem 940. The MVS subsystem 920 separates the input saltwater into two streams, one of which is sent to the first desalinator subsystem 930 and the other of which is sent to the second desalinator subsystem 930. The MVS subsystem 920 may be the multivalent cation-extracting stack 172 or the multivalent anion-extracting stack 174. The multivalent cation-extracting stack 172 outputs multivalent cation-rich and multivalent cation-poor water, while the multivalent anion-extracting stack 174 outputs multivalent anion-rich and multivalent anion-poor water. The multivalent cation-poor water is relatively rich in multivalent anions and the multivalent anion-poor water is relatively rich multivalent cations. In the context of the MVS-SDS 902, the multivalent cation-poor water that the multivalent cation-extracting stack 172 outputs may also be referred to as “multivalent anion-rich water” as it is relatively rich in multivalent anions; analogously, the multivalent anion-poor water that the multivalent anion-extracting stack 174 outputs may also be referred to as “multivalent cation-rich water” as it is relatively rich in multivalent cations. The first desalinator subsystem 930 and the second desalinator subsystem 940 may each comprise at least one of a reverse osmosis device, a nanofiltration device, an electrodialysis device, a thermal desalination device, and a membrane distillation desalination device. Similar to the MVS-PDS 102, the MVS-SDS 902 may further comprise any one or more of the monovalent ion species addition subsystem 110, the salt precipitating subsystem 109, the polishing subsystem 111, the monovalent salt-concentrating stack 165, and the desalination subsystem 164 (not shown in FIG. 9), fluidly coupled to each other in a manner analogous to how they are coupled together in the MVS-PDS 102.

In the MVS-SDS 902, the input saltwater is supplied along the input conduit 104 and separator input conduit 913, which feeds the MVS subsystem 920. As shown in FIG. 9, the monovalent ion addition subsystem 110 may optionally add one or more monovalent salts or monovalent acids to the input saltwater via the monovalent ion addition conduit 112.

When the MVS subsystem 920 comprises the multivalent cation-extracting stack 172, it outputs a multivalent cation-rich water on a first output conduit 921 to the first desalinator subsystem 930 and a multivalent anion-rich water (which is poor in multivalent cations) on a second output conduit 922 to the second desalinator subsystem 940. Analogously, when the MVS subsystem 920 comprises the multivalent anion-extracting stack 174, it outputs a multivalent anion-rich water on the first output conduit 921 to the first desalinator subsystem 930 and a multivalent cation-rich water (which is poor in multivalent anions) on the second output conduit 922 to the second desalinator subsystem 940. The first and second desalinator subsystems 930,940 may comprise, for example, any one or more of electrodialysis desalinator devices, reverse osmosis desalinator devices, nanofiltration desalinator devices, membrane distillation desalinator devices, and thermal evaporation desalinator devices.

The product water produced by the desalinator subsystems 930,940 may be discharged from the MVS-SDS 902 through output conduits 931,941. Alternatively, the product water from the first desalinator subsystem 930 and second desalinator subsystem 940 may be further desalinated by optional RO subsystems (not shown in FIG. 9) before being discharged. The concentrate that the first desalinator subsystem 930 produces and outputs, and the concentrate that the second desalinator subsystem 940 produces and outputs, may be supplied to the salt precipitating subsystem 109 via concentrate conduits 932,942 and reacted together to create solid precipitates of multivalent species that may be solids such as CaSO₄. The precipitate rich product is removed for other industrial use via the output conduit 160. Alternatively, the concentrate may be recovered via the concentrate conduits 932,942 for other industrial uses or be discharged directly from the MVS-SDS 902.

The reaction in the salt precipitating subsystem 109 also produces a brine that is made available via one of the conduits 152. The optional polishing subsystem 111 provides a polishing process to remove or recover the multivalent cations that remain in the brine discharged from the salt precipitating subsystem 109. One or more precipitation agents, such as sodium hydroxide, sodium carbonate, calcium hydroxide and their combinations may be added through the input conduit 156 and the precipitate rich product may be removed via the output conduit 158. The monovalent ion species entering the MVS-SDS 902 remain in the brine stream that the salt precipitating subsystem 109 outputs. This monovalent salt-rich brine may optionally be recirculated, via a conduit 972, as the input saltwater when the input saltwater is poor in monovalent ion species, or be removed from the MVS-SDS 902 through the output conduit 160 when the input saltwater is already rich in monovalent ion species. When the monovalent salt-rich brine is recirculated to the input saltwater, it may be further concentrated using the monovalent salt-concentrating stack 165.

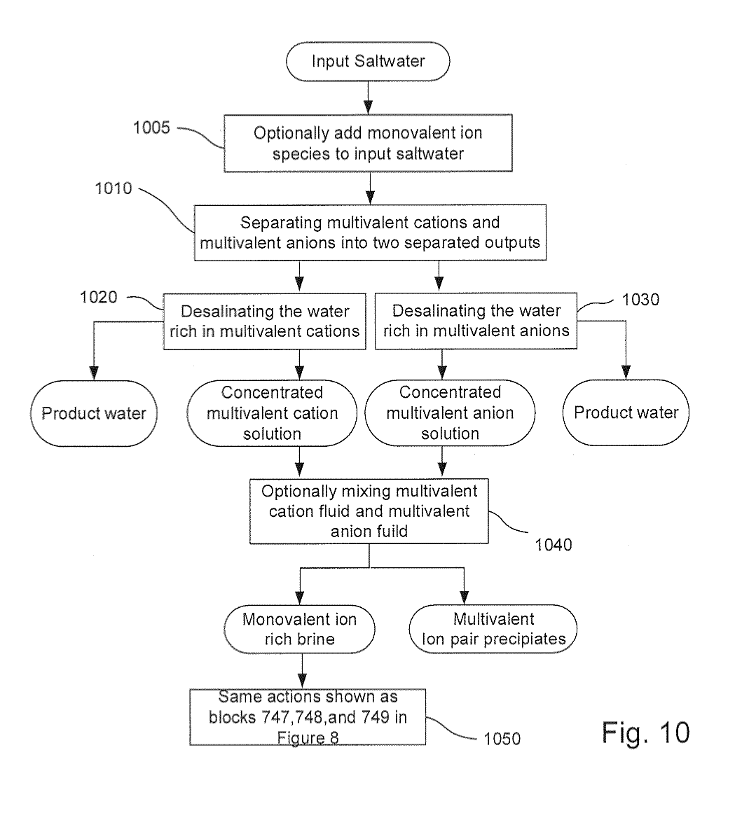

Referring now to the flowchart of FIG. 10, there is shown a process desalinating input saltwater that comprises scalable multivalent ion pairs. The process may be performed using the embodiment of the MVS-SDS 902 shown in FIG. 9, which is how the process is described below, or alternatively the process may be performed using an alternative embodiment of the MVS-SDS 902 (not shown). The process comprises:
(a) processing and separating [1010] the input saltwater into two streams: one of multivalent cation-rich water and another of multivalent anion-rich water, which in the MVS-SDS 902 is done by using the MVS subsystem 920;
(b) directing the multivalent cation-rich water along a first path to the first desalinator subsystem 930 [1020], which may be based on any one or more of electrodialysis, reverse osmosis, thermal desalination, and membrane distillation desalination, to desalinate the multivalent cation-rich water;
(c) directing multivalent anion-rich water along a second path to the second desalinator subsystem 940 [1030], which may be based on any one or more of electrodialysis, reverse osmosis, thermal desalination, and membrane distillation desalination, to desalinate the multivalent anion-rich water;
(d) optionally adding [1005] monovalent ion species to the input saltwater via the monovalent ion addition conduit 112 from the monovalent ion species addition subsystem 110;
(e) optionally mixing [1040] the multivalent cation-rich water, which circulates through the multivalent cation-rich fluid circuit, and the multivalent anion-rich water, which circulates through the multivalent anion-rich fluid circuit, to produce multivalent ion pair precipitates of non-soluble species and monovalent ion rich brine; and
(f) optionally desalinating water products from the first desalinator subsystem 930 and second desalinator subsystem 940 using the desalination subsystem 164.

The monovalent ion rich brine that the MVS-SDS 902 produces [1040] may be processed as described in detail in respect of FIG. 8, above [1050].

The process of FIG. 10 may further comprise reversing, periodically, the polarity of the MVS subsystem 920 to descale any scalants that have accumulated on the MVS subsystem's 920 ion exchange membranes.

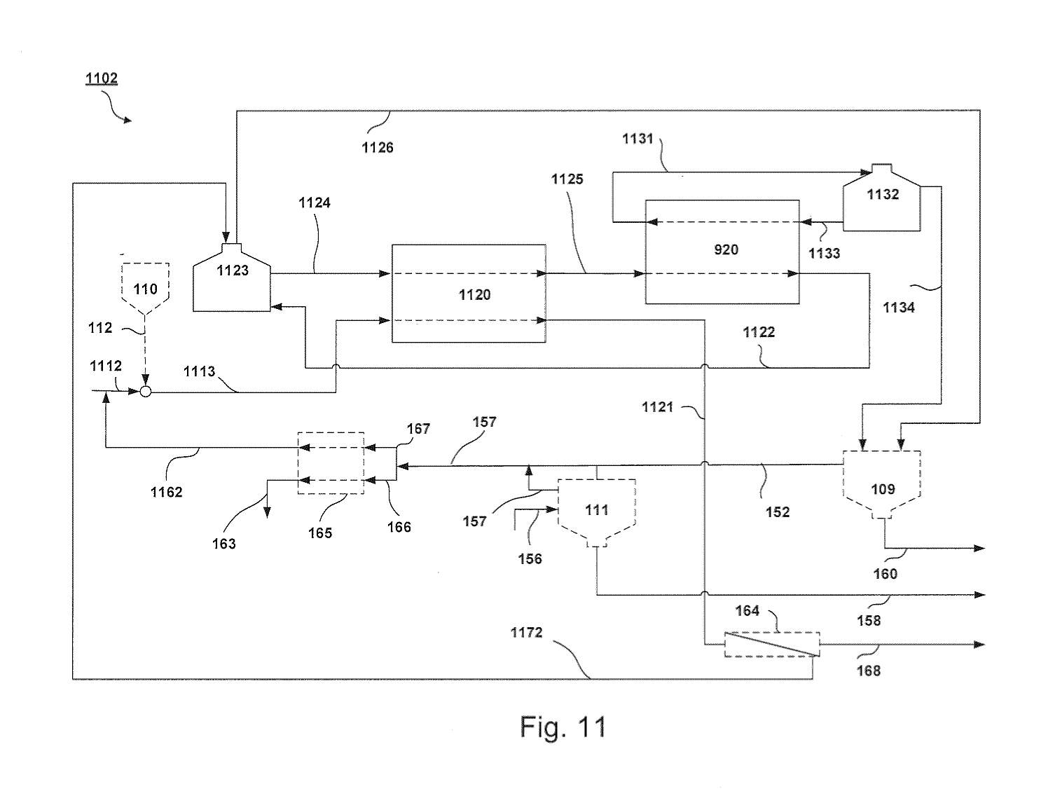

In another embodiment, illustrated in FIG. 11, there is shown a hybrid desalination system that combines electrodialysis and multivalent ion separation (“EDR-DS-MVS”) 1102. The EDR-DS-MVS 1102 comprises a) an electrodialysis (ED or EDR) subsystem 1120; and b) the MVS subsystem 920, wherein the electrodialysis subsystem 1120 operates in conjunction with the MVS subsystem 920. The electrodialysis subsystem 1120 receives the input saltwater and removes salts from the input saltwater to produce product water and concentrated saltwater. The MVS subsystem 920 receives as its feed the concentrated saltwater from the electrodialysis subsystem 1120. The MVS subsystem 920 is the multivalent cation-extracting stack 172, which removes multivalent cations from the concentrated saltwater, or the multivalent anion-extracting stack 174, which removes multivalent anions from the concentrated saltwater. The MVS subsystem 920 accordingly removes multivalent cations or multivalent anions from the concentrated saltwater, thereby reducing the concentration of the scaling multivalent ion pairs in the concentrated saltwater to below their solubility limit, increasing the ability of the electrodialysis subsystem 1120 to recover water. The EDR-DS-MVS 1102 may further comprise any one or more of the monovalent ion species addition subsystem 110, the salt precipitating subsystem 109, the polishing subsystem 111, the monovalent salt-concentrating stack 165, and the desalination subsystem 164, fluidly coupled to each other as shown in FIG. 11.

Input saltwater to be desalinated is supplied to the electrodialysis stack 1120 along input saltwater conduits 1112,1113. The monovalent ion species addition subsystem 110 may add one or more monovalent salts and monovalent acids to the input saltwater via the monovalent ion addition conduit 112. The electrodialysis stack 1120 removes all the ion species including monovalent and multivalent ions from the input saltwater and outputs concentrated saltwater on a concentrate output conduit 1125 to the MVS subsystem 920 and outputs product water on an output conduit 1121. The product water may be discharged from the EDR-DS-MVS 1102 through the discharge conduit 168 via another conduit 1121, or may be further desalinated before discharge by the desalination subsystem 164, which produces desalinated permeate that is discharged through the discharge conduit 168. The concentrated brine output by the desalination subsystem 164 is returned via a conduit 1172 to a storage tank 1123 and mixed there with saltwater for further treatment in the EDR-DS-MVS 1102.

The MVS subsystem 920 receives concentrated saltwater from the electrodialysis subsystem 1120 via the concentrate output conduit 1125, and outputs multivalent cation-rich water (if the MVS subsystem 920 comprises the multivalent cation-extracting stack 172) or multivalent anion-rich water (if the MVS subsystem 920 comprises the multivalent anion-extracting stack 174) via a multivalent ion output conduit 1131 to the multivalent ion tank 1132. From the multivalent ion tank 1132, the multivalent ion-rich saltwater may be recirculated via a return conduit 1133 to the MVS subsystem 920, or supplied to the salt precipitating subsystem 109 via a multivalent ion concentrate line 1134. The MVS subsystem 920 also outputs multivalent anion-rich water on a conduit 1122 if the MVS subsystem 920 is the multivalent cation-extracting stack 172 (as the multivalent cation-poor water the stack 172 outputs on the conduit 1122 is relatively rich in multivalent anions) or multivalent cation-rich water on the conduit 1122 if the MVS subsystem 920 is the multivalent anion-extracting stack 174 (as the multivalent anion-poor water the stack 172 outputs on the conduit 1122 is relatively rich in multivalent cations). This water may be returned to the electrodialysis subsystem 1120 and the multivalent anions or multivalent cations in that water may be concentrated there and stored in the storage tank 1123. The EDR-DS-MVS 1102 accordingly produces water rich in one multivalent ion in the storage tank 1123, and water rich in an oppositely charged multivalent ion in the multivalent ion tank 1132.

Multivalent ion-rich feeds from the tanks 1123,1132 may be supplied to the salt precipitating subsystem 109 to generate solid precipitates of multivalent ion pairs which may be solids such as CaSO₄. These precipitates are discharged via the output conduit 160. Alternatively, the multivalent ion rich feeds from the tanks 1123,1132 may be recovered for other industrial uses or be discharged directly from the EDR-DS-MVS 1102.

The reaction in the salt precipitating subsystem 109 also produces a brine that is made available via a conduit 152. The optional polishing subsystem 111 performs a polishing process to remove or recover multivalent ions that remain in the brine. One or more precipitation agents, such as sodium hydroxide, sodium carbonate, calcium hydroxide and their combinations may be added through the input conduit 156 and the precipitate rich product may be removed via the output conduit 158. The monovalent ion species entering the EDR-DS-MVS 1102 remain in the brine in the conduit 152 from the salt precipitating subsystem 109. This monovalent ion-rich brine may optionally be recirculated through a conduit 1162 and mixed with the input saltwater when the input saltwater is poor in monovalent ion species, or be removed from the EDR-DS-MVS 1102 through the output conduit 158 when the input saltwater is rich in monovalent ion species. When the monovalent ion-rich brine is mixed with the input saltwater, it may be further concentrated using the monovalent salt-concentrating stack 165, which is described in detail in FIG. 6 above.

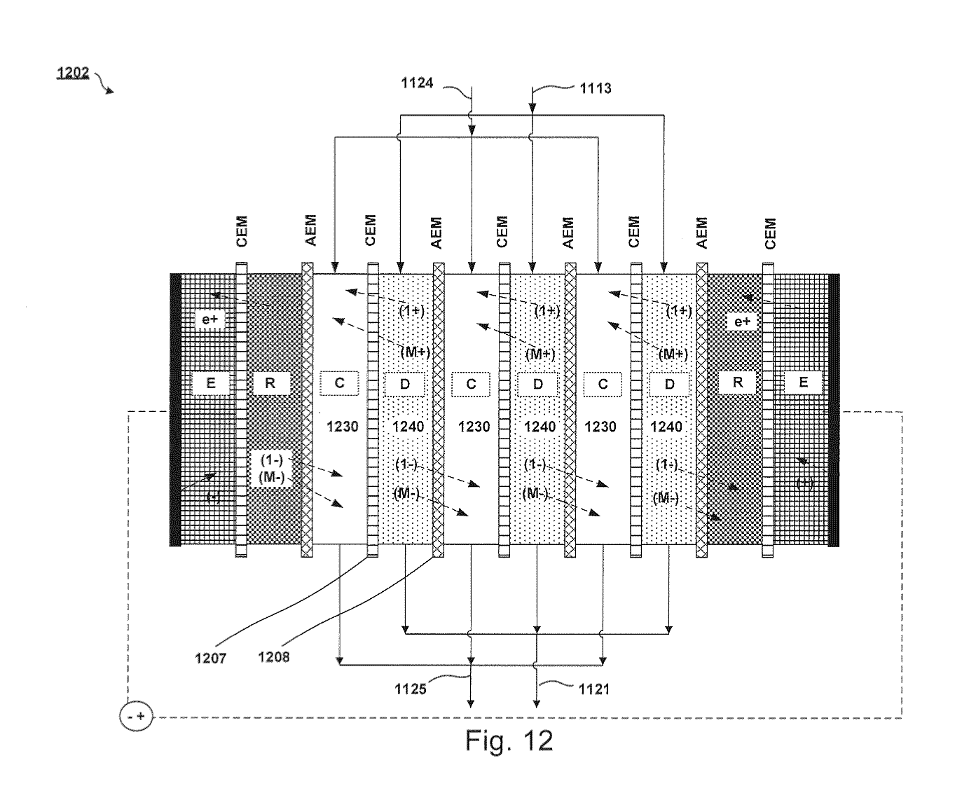

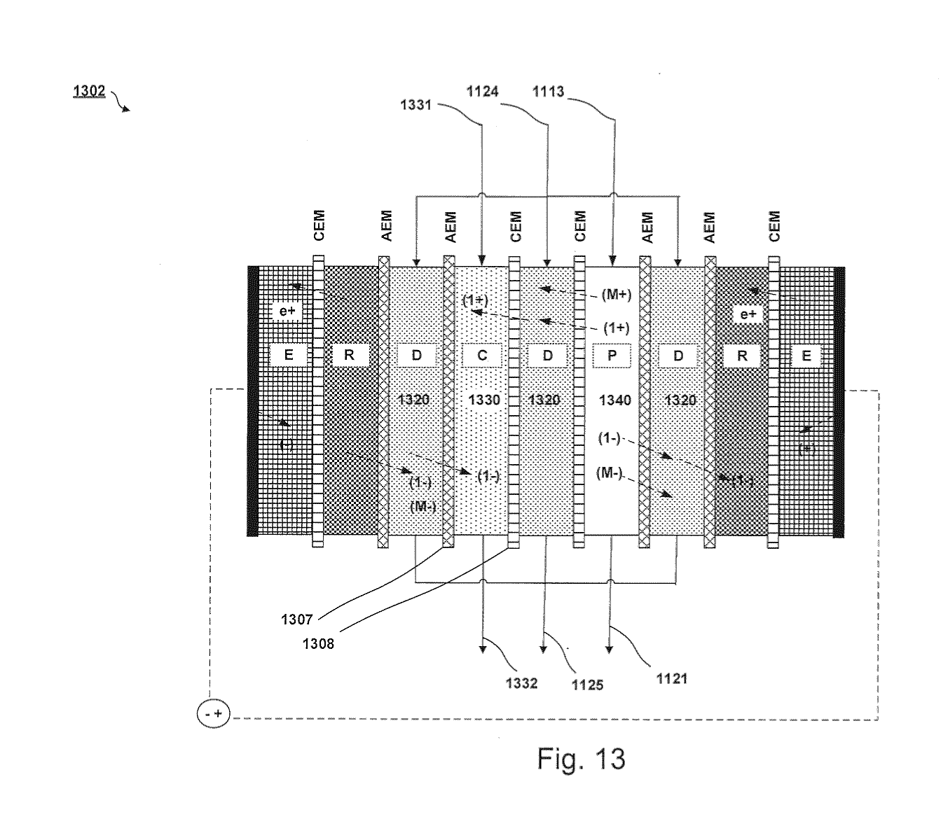

The electrodialysis subsystem 1120 may be a general electrodialysis stack 1202 as shown in FIG. 12, or a multi-compartment electrodialysis stack (“MC-EDR stack”) 1302 as shown in FIG. 13. Both of the stacks 1202,1302 may be operated in forward polarity or reverse polarity.

The stack 1202 in FIG. 12 employs the same electrode arrangement and the optional rinse chambers as already described in detail in respect of the multivalent cation-extracting stack 172. An alternating series of cation exchange membranes 1207 and anion exchange membranes 1208 delineate C-chambers 1230 and D-chambers 1240. When sufficient voltage is applied across the stack 1202, ion migration occurs and results in concentrated saltwater being confined to the C-chambers 1230 and the product water being confined to the D-chambers 1240. The product water is then routed to the desalination subsystem 164 or directly to the discharge conduit 168, and the concentrated saltwater is routed to the MVS subsystem 920.

FIG. 13 shows an example embodiment of the MC-EDR stack 1302. The depicted MC-EDR stack 1302 is as disclosed in co-pending Patent Cooperation Treaty patent application PCT/CA2012/000843 (published as WO2013/037047), the entirety of which is hereby incorporated by reference herein. The MC-EDR stack 1302 employs the same electrode arrangement and the optional rinse chambers as already described respect of the multivalent cation-extracting stack 172. An alternating series of cation exchange membranes 1308 and anion exchange membranes 1307 delineate C-chambers 1330 and D-chambers 1320, and also one P-chamber 1340. When sufficient voltage is applied across the MC-EDR stack 1302, ion migration occurs and concentrated saltwater is confined to the D-chambers 1320 and C-chambers 1330 and the product water is confined to the P-chamber 1340. The product water is then routed to the desalination subsystem 164 or directly to the discharge conduit 168, and the concentrated saltwater is routed to the MVS subsystem 920.

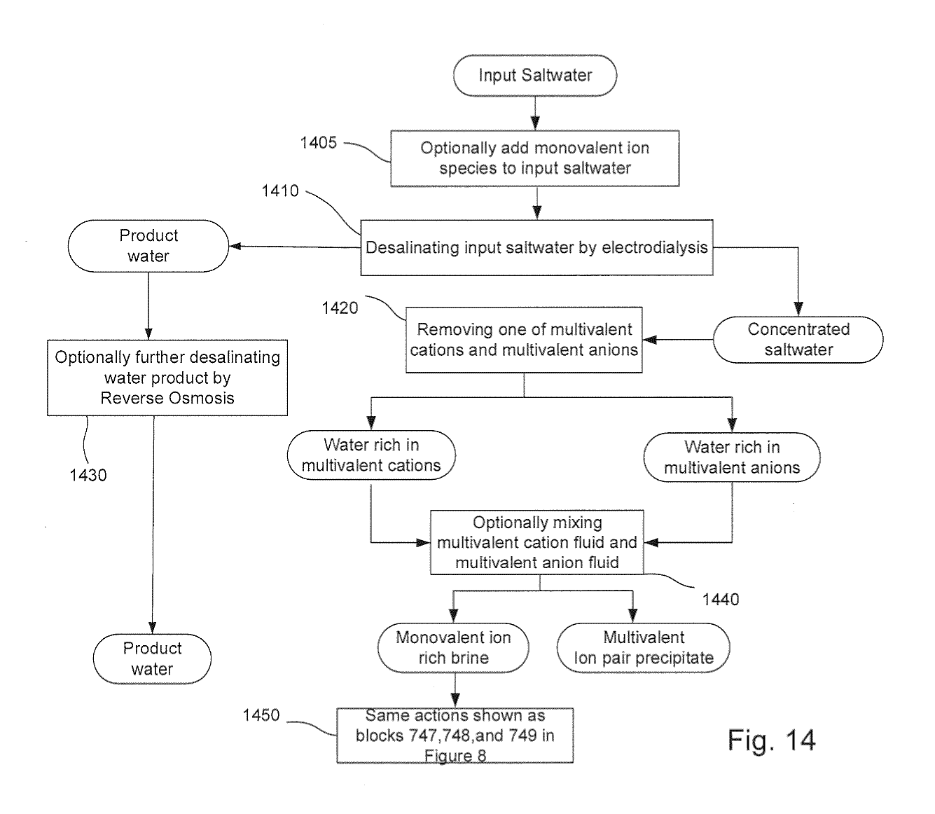

Referring now to FIG. 14, there is shown a flowchart of a process for desalinating the input saltwater when the input saltwater comprises multivalent ion species. The process may be performed using the depicted embodiment of the EDR-DS-MVS 1102, which is how the process is described below, or performed using an alternative embodiment of the EDR-DS-MVS 1102 (not shown). The process comprises:
(a) desalinating the input saltwater [1410] using the electrodialysis subsystem 1120 to generate product water and concentrated saltwater;
(b) directing the concentrated saltwater to the MVS subsystem 920, which removes [1420] the multivalent cation species or the multivalent anion species from the concentrated saltwater and produces [1430] multivalent cation-rich water or multivalent anion-rich water when operated in conjunction with the electrodialysis subsystem 1120;
(c) optionally adding [1405] monovalent ion species to the input saltwater via using the monovalent ion species addition subsystem 110;
(d) optionally desalinating [1430] the product water output from the electrodialysis subsystem 1120 using the desalination subsystem 164; and
(e) optionally mixing [1440] the multivalent cation-rich water or the multivalent anion-rich water to produce multivalent ion pair precipitates and monovalent ion rich brine.

The monovalent ion rich brine produced by the EDR-DS-MVS 1102 may be processed [1450] as described in detail in respect of FIG. 8, above.

The process of FIG. 14 may further comprise reversing, periodically, the polarity of the MVS subsystem 920 to descale any scalants that have accumulated on the MVS subsystem's 920 ion exchange membranes.

It is contemplated that any part of any aspect or embodiment discussed in this specification can be implemented or combined with any part of any other aspect or embodiment discussed in this specification.

FIGS. 7, 8, 10, and 14 are flowcharts of example methods. Some of the blocks illustrated in the flowcharts may be performed in an order other than that which is described. Also, it should be appreciated that not all of the blocks described in the flowcharts are required to be performed, that additional blocks may be added, and that some of the illustrated blocks may be substituted with other blocks.

While particular embodiments have been described in the foregoing, it is to be understood that other embodiments are possible and are intended to be included herein. It is clear to any person skilled in the art that modification of and adjustments to the foregoing embodiments, not shown, are possible.

1. A process for desalinating saltwater, the input saltwater comprising multivalent ion pairs and the process comprising:
(a) circulating the input saltwater through a common fluid circuit comprising a multivalent cation-extracting branch and a multivalent anion-extracting branch, wherein a portion of the cation-extracting branch and a portion of the anion-extracting branch are distinct from each other;
(b) removing multivalent cations from the input saltwater when the input saltwater is in the portion of the cation-extracting branch distinct from the anion-extracting branch, wherein the multivalent cations are removed using a multivalent cation-extracting stack comprising alternating cation exchange membranes and monovalent anion exchange membranes; and
(c) removing multivalent anions from the input saltwater when the input saltwater is in the portion of the anion-extracting branch distinct from the cation-extracting branch, wherein the multivalent anions are removed using a multivalent anion-extracting stack comprising alternating anion exchange membranes and monovalent cation exchange membranes.

2. The process of claim 1 further comprising:
(a) transferring the multivalent cations removed from the input saltwater to a multivalent cation fluid circuit distinct from the common fluid circuit; and
(b) transferring the multivalent anions removed from the input saltwater to a multivalent anion fluid circuit distinct from the common fluid circuit and the multivalent cation fluid circuit.

3. The process of claim 1 or 2 further comprising adding monovalent ion species to the input saltwater upstream of the portions of the anion-extracting and cation-extracting branches where the multivalent anions and cations are removed, respectively.

4. The process of any one of claims 1 to 3 further comprising periodically reversing polarity of one or both of the multivalent anion-extracting stack and multivalent cation-extracting stack to perform descaling, wherein reversing the polarity of either of the stacks comprises reversing the polarity of an electric field applied across that stack and swapping positions of concentrate and product chambers of that stack.

5. The process of claim 4 wherein reversing the polarity of either of the stacks further comprises flushing the concentrate chambers of that stack with product water that has exited the product chambers of that stack.

6. The process of any one of claims 1 to 4 wherein removing the multivalent cations from the input saltwater generates product water and multivalent cation-rich water and wherein removing the multivalent anions from the input saltwater generates product water and multivalent anion-rich water, and further comprising using reverse osmosis to further desalinate the product water generated from removing the multivalent cations and multivalent anions.

7. The process of claim 6 further comprising generating a precipitate comprising multivalent ion species and a monovalent salt-rich brine by mixing the multivalent cation-rich and multivalent anion-rich waters.

8. The process of claim 7 further comprising polishing the monovalent salt-rich brine by precipitating multivalent cations therefrom.

9. The process of claim 7 or 8 further comprising using an electrodialysis stack (“monovalent salt-concentrating stack”), which comprises alternating monovalent anion exchange membranes and monovalent cation exchange membranes, to concentrate the monovalent salt-rich brine.

10. The process of claim 9 further comprising adding the monovalent salt-rich brine, after it has been concentrated by the monovalent salt-concentrating stack, to the input saltwater upstream of the portions of the anion-extracting and cation-extracting branches where the multivalent anions and multivalent cations are removed, respectively.

11. A system for desalinating input saltwater, the system comprising:
(a) a multivalent cation-extracting electrodialysis stack (“multivalent cation-extracting stack”), comprising:
(i) alternating cation exchange membranes and monovalent anion exchange membranes; and
(ii) alternating product chambers and concentrate chambers bounded by the cation exchange membranes and monovalent anion exchange membranes, wherein the multivalent cation-extracting stack removes salts comprising multivalent cations and monovalent anions from its product chambers to its concentrate chambers while desalinating when sufficient voltage is applied across it;
(b) a multivalent anion-extracting electrodialysis stack (“multivalent anion-extracting stack”), comprising:
(i) alternating anion exchange membranes and monovalent cation exchange membranes; and
(ii) alternating product chambers and concentrate chambers bounded by the anion exchange membranes and the monovalent cation exchange membranes, wherein the multivalent anion-extracting stack removes salts comprising monovalent cations and multivalent anions from its product chambers to its concentrate chambers while desalinating when sufficient voltage is applied across it;
(c) an input saltwater source fluidly coupled to inlets of the product chambers of the multivalent cation-extracting and anion-extracting stacks to feed input saltwater to the inlets.

12. The system of claim 11 wherein the input saltwater source comprises a water tank, and wherein outlets of the product chambers of the multivalent cation-extracting and anion-extracting stacks are fluidly coupled to the water tank to form a common fluid circuit comprising the water tank and the product chambers of the multivalent cation-extracting and anion-extracting stacks.

13. The system of claim 11 or 12 further comprising:
(a) a multivalent cation tank fluidly coupled to an inlet and outlet of the concentrate chambers of the multivalent cation-extracting stack to form a multivalent cation fluid circuit; and
(b) a multivalent anion tank fluidly coupled to an inlet and outlet of the concentrate chambers of the multivalent anion-extracting stack to form a multivalent anion fluid circuit.

14. The system of any one of claims 11 to 13 further comprising a monovalent ion species addition subsystem comprising a reserve of at least one of a monovalent salt and a monovalent acid, the monovalent ion species addition subsystem fluidly coupled to the product chambers of the multivalent cation-extracting and anion-extracting stacks to add one or both of the monovalent salt and monovalent acid to the input saltwater.

15. The system of any one of claims 11 to 14 further comprising a desalination subsystem fluidly coupled to the product chambers of the multivalent cation-extracting and anion-extracting stacks such that product water exiting the product chambers of the multivalent cation-extracting and anion-extracting stacks can be further desalinated, wherein the desalination subsystem comprises one of a reverse osmosis device, a forward osmosis device, a nanofiltration device, an electrodialysis device, a thermal desalination device, and a membrane distillation device.

16. The system of any one of claims 11 to 15 further comprising a multivalent ion pair salt precipitating subsystem (“salt precipitating subsystem”) fluidly coupled to the concentrate chambers of the multivalent cation-extracting and anion-extracting stacks such that multivalent ion pairs extracted by the multivalent cation-extracting and anion-extracting stacks can be precipitated and discharged from the system.

17. The system of claim 16 wherein the salt precipitating subsystem outputs a monovalent ion rich brine, and wherein the system further comprises a multivalent salt precipitation polishing subsystem (“polishing subsystem”) fluidly coupled to the salt precipitating subsystem to receive the brine and configured to remove multivalent cations therefrom.

18. The system of claim 16 wherein the salt precipitating subsystem outputs a monovalent ion rich brine, and wherein the system further comprises a monovalent salt-concentrating electrodialysis stack (“monovalent salt-concentrating stack”) fluidly coupled to the salt precipitating subsystem to receive the brine and configured to concentrate the brine.

19. The system of claim 18 wherein the monovalent salt-concentrating stack is fluidly coupled to the product chambers of the multivalent cation-extracting and anion-extracting stacks and configured to add the brine after it has been concentrated to the input saltwater such that monovalent ion concentration of the input saltwater while in the multivalent cation-extracting and anion-extracting stacks is increased.

20. The system of claim 18 or 19 wherein the monovalent salt-concentrating stack comprises alternating monovalent anion exchange membranes and monovalent cation exchange membranes.

21. A process for desalinating saltwater, the input saltwater comprising multivalent ion pairs and the process comprising:
(a) separating the input saltwater into two streams;
(b) transferring either multivalent cations or multivalent anions from one of the streams to the other of the streams to cause one of the streams to comprise multivalent anion-rich water and the other of the streams to comprise multivalent cation-rich water, wherein the multivalent anion-rich water has a higher concentration of multivalent anions and a lower concentration of multivalent cations than the multivalent cation-rich water, and wherein the transferring is performed using a multivalent cation-extracting stack comprising alternating cation exchange membranes and monovalent anion exchange membranes or a multivalent anion-extracting stack comprising alternating anion exchange membranes and monovalent cation exchange membranes;
(c) desalinating the multivalent anion-rich water to generate a concentrated multivalent anion solution and product water; and
(d) desalinating the multivalent cation-rich water, separately from the multivalent anion-rich water, to generate a concentrated multivalent cation solution and product water.

22. The process of claim 21 wherein desalinating the multivalent anion-rich water and desalinating the multivalent cation-rich water is performed by one of reverse osmosis, forward osmosis, nanofiltration, electrodialysis, thermal desalination, and membrane distillation.

23. The process of claim 21 or 22 further comprising adding monovalent ion species to the input saltwater prior to transferring either multivalent cations or multivalent anions from one of the streams to the other of the streams.

24. The process of any one of claims 21 to 23 further comprising periodically reversing polarity of the multivalent anion-extracting stack or multivalent cation-extracting stack to perform descaling, wherein reversing the polarity either of the stacks comprises reversing the polarity of an electric field applied across that stack and swapping positions of concentrate and product chambers of that stack.

25. The process of claim 24 wherein reversing the polarity of either of the stacks further comprises flushing the concentrate chambers of that stack with product water that has exited the product chambers of that stack.

26. The process of any one of claims 21 to 24 further comprising generating a precipitate comprising multivalent ion species and a monovalent salt-rich brine by mixing the concentrated multivalent anion solution and the concentrated multivalent cation solution.

27. The process of claim 26 further comprising polishing the monovalent salt-rich brine by precipitating multivalent cations therefrom.

28. The process of claim 26 or 27 further comprising using an electrodialysis stack (“monovalent salt-concentrating stack”), which comprises alternating monovalent anion exchange membranes and monovalent cation exchange membranes, to concentrate the monovalent salt-rich brine.

29. The process of claim 28 further comprising adding the monovalent salt-rich brine, after it has been concentrated by the monovalent salt-concentrating stack, to the input saltwater upstream of the portions of the anion-extracting and cation-extracting branches where the multivalent anions and multivalent cations are removed, respectively.

30. A system for desalinating input saltwater, the system comprising:
(a) a multivalent ion separator subsystem, comprising either:
(i) a multivalent cation-extracting electrodialysis stack (“multivalent cation-extracting stack”), comprising:
(1) alternating cation exchange membranes and monovalent anion exchange membranes; and
(2) alternating product chambers and concentrate chambers bounded by the cation exchange membranes and monovalent anion exchange membranes, wherein the multivalent cation-extracting stack removes salts comprising multivalent cations and monovalent anions from its product chambers to its concentrate chambers while desalinating when sufficient voltage is applied across it; or
(ii) a multivalent anion-extracting electrodialysis stack (“multivalent anion-extracting stack”), comprising:
(1) alternating anion exchange membranes and monovalent cation exchange membranes; and
(2) alternating product chambers and concentrate chambers bounded by the anion exchange membranes and the monovalent cation exchange membranes, wherein the multivalent anion-extracting stack removes salts comprising multivalent anions and monovalent cations from its product chambers to its concentrate chambers while desalinating when sufficient voltage is applied across it; and
(b) first and second desalinator subsystems fluidly coupled to the product chambers and concentrate chambers of the multivalent ion separator subsystem, respectively, wherein each of the desalinator subsystems outputs product water and a concentrated multivalent ion solution while desalinating.

31. The system of claim 30 wherein each of the desalinator subsystems comprises one of a reverse osmosis device, a forward osmosis device, a nanofiltration device, an electrodialysis device, a thermal desalination device, and a membrane distillation device.

32. The system of claim 30 or 31 further comprising a monovalent ion species addition subsystem comprising a reserve of at least one of a monovalent salt and a monovalent acid, the monovalent ion species addition subsystem fluidly coupled to the product chambers of the multivalent ion separator subsystem to add one or both of the monovalent salt and monovalent acid to the input saltwater.

33. The system of any one of claims 30 to 32 further comprising a multivalent ion pair salt precipitating subsystem (“salt precipitating subsystem”) fluidly coupled to the first and second desalinators to receive the concentrated multivalent ion solution that each of the desalinators outputs and configured to precipitate and discharge multivalent ion pairs from the system.

34. The system of claim 33 wherein the salt precipitating subsystem outputs a monovalent ion rich brine, and wherein the system further comprises a multivalent salt precipitation polishing subsystem (“polishing subsystem”) fluidly coupled to the salt precipitating subsystem to receive the brine and configured to remove multivalent cations therefrom.

35. The system of claim 33 wherein the salt precipitating subsystem outputs a monovalent ion rich brine, and wherein the system further comprises a monovalent salt-concentrating electrodialysis stack (“monovalent salt-concentrating stack”) fluidly coupled to the salt precipitating subsystem to receive the brine and configured to concentrate the brine.

36. The system of claim 35 wherein the monovalent salt-concentrating stack is fluidly coupled to the product chambers of the multivalent cation-extracting and anion-extracting stacks and configured to add the brine after it has been concentrated to the input saltwater such that monovalent ion concentration of the input saltwater while in the multivalent cation-extracting and anion-extracting stacks is increased.

37. The system of claim 35 or 36 wherein the monovalent salt-concentrating stack comprises alternating monovalent anion exchange membranes and monovalent cation exchange membranes.

38. A process for desalinating input saltwater, the input saltwater comprising multivalent ion pairs and the process comprising:
(a) desalinating the input saltwater using electrodialysis to produce product water and concentrated saltwater; and
(b) transferring either multivalent cations or multivalent anions from the concentrated saltwater to other water to generate multivalent anion-rich water and multivalent cation-rich water, wherein the multivalent anion-rich water has a higher concentration of multivalent anions and a lower concentration of multivalent cations than the multivalent cation-rich water, and wherein the transferring is performed using a multivalent cation-extracting stack comprising alternating cation exchange membranes and monovalent anion exchange membranes or a multivalent anion-extracting stack comprising alternating anion exchange membranes and monovalent cation exchange membranes.

39. The process of claim 38 further comprising adding monovalent ion species to the input saltwater prior to desalinating the input saltwater using electrodialysis.

40. The process of claim 38 or 39 further comprising periodically reversing polarity of the multivalent anion-extracting stack or multivalent cation-extracting stack to perform descaling, wherein reversing the polarity of either of the stacks comprises reversing the polarity of an electric field applied across that stack and swapping positions of concentrate and product chambers of that stack.

41. The process of claim 40 wherein reversing the polarity of either of the stacks further comprises flushing the concentrate chambers of that stack with product water that has exited the product chambers of that stack.

42. The process of any one of claims 38 to 40 further comprising using one of reverse osmosis, forward osmosis, nanofiltration, electrodialysis, thermal desalination, and membrane distillation to further desalinate the product water.

43. The process of any one of claims 38 to 42 further comprising generating a precipitate comprising multivalent ion species and a monovalent salt-rich brine by mixing the multivalent cation-rich and multivalent anion-rich waters.

44. The process of claim 43 further comprising polishing the monovalent salt-rich brine by precipitating multivalent cations therefrom.

45. The process of claim 43 or 44 further comprising using an electrodialysis stack (“monovalent salt-concentrating stack”), whose ion exchange membranes comprise alternating monovalent anion exchange membranes and monovalent cation exchange membranes, to concentrate the monovalent salt-rich brine.

46. The process of claim 45 further comprising adding the monovalent salt-rich brine, after it has been concentrated by the monovalent salt-concentrating stack, to fresh input saltwater prior to desalinating the fresh input saltwater using electrodialysis.

47. A system for desalinating input saltwater, the input saltwater comprising multivalent ion pairs and the system comprising:
(a) an electrodialysis subsystem; and
(b) a multivalent ion separator subsystem, comprising either:
(i) a multivalent cation-extracting electrodialysis stack (“multivalent cation-extracting stack”), comprising:
(1) alternating cation exchange membranes and monovalent anion exchange membranes; and
(2) alternating product chambers and concentrate chambers bounded by the cation exchange membranes and monovalent anion exchange membranes, wherein the multivalent cation-extracting stack removes salts comprising multivalent cations and monovalent anions from its product chambers to its concentrate chambers while desalinating when sufficient voltage is applied across it, and wherein its product chambers are fluidly coupled to the electrodialysis subsystem to receive concentrated saltwater discharged from the electrodialysis subsystem; or
(ii) a multivalent anion-extracting electrodialysis stack (“multivalent anion-extracting stack”), comprising:
(1) alternating anion exchange membranes and monovalent cation exchange membranes; and
(2) alternating product chambers and concentrate chambers bounded by the anion exchange membranes and the monovalent cation exchange membranes, wherein the multivalent anion-extracting stack removes salts comprising multivalent anions and monovalent cations from its product chambers to its concentrate chambers while desalinating when sufficient voltage is applied across it, and wherein its product chambers are fluidly coupled to the electrodialysis subsystem to receive concentrated saltwater discharged from the electrodialysis subsystem.

48. The system of claim 47 wherein the input saltwater source comprises a water tank, and wherein outlets of the product chambers of the multivalent ion separator subsystem are fluidly coupled to the water tank to form a common fluid circuit comprising the water tank, the concentrate chambers of the electrodialysis stack, and the product chambers of the multivalent ion separator subsystem.

49. The system of claim 47 or 48 further comprising a multivalent ion tank fluidly coupled to an inlet and outlet of the concentrate chambers of the multivalent ion separator subsystem to form a multivalent ion fluid circuit.

50. The system of any one of claims 47 to 49 further comprising a monovalent ion species addition subsystem comprising a reserve of at least one of a monovalent salt and a monovalent acid, the monovalent ion species addition subsystem fluidly coupled to the product chambers of the electrodialysis stack to add one or both of the monovalent salt and monovalent acid to the input saltwater.

51. The system of any one of claims 47 to 50 further comprising a desalination subsystem fluidly coupled to the product chambers of the electrodialysis stack such that product water exiting the product chambers of the electrodialysis stack can be further desalinated, wherein the desalination subsystem comprises one of a reverse osmosis device, a forward osmosis device, a nanofiltration device, an electrodialysis device, a thermal desalination device, and a membrane distillation device.

52. The system of any one of claims 47 to 51 further comprising a multivalent ion pair salt precipitating subsystem (“salt precipitating subsystem”) fluidly coupled to the concentrate and product chambers of the multivalent ion separator subsystem such that multivalent ions extracted by the multivalent ion separator subsystem can be precipitated and discharged from the system.

53. The system of claim 52 wherein the salt precipitating subsystem outputs a monovalent ion rich brine, and wherein the system further comprises a multivalent salt precipitation polishing subsystem (“polishing subsystem”) fluidly coupled to the salt precipitating subsystem to receive the brine and configured to remove multivalent cations therefrom.

54. The system of claim 52 wherein the salt precipitating subsystem outputs a monovalent ion rich brine, and wherein the system further comprises a monovalent salt-concentrating electrodialysis stack (“monovalent salt-concentrating stack”) fluidly coupled to the salt precipitating subsystem to receive the brine and configured to concentrate the brine.

55. The system of claim 54 wherein the monovalent salt-concentrating stack is fluidly coupled to the product chambers of the electrodialysis stack and configured to add the brine after it has been concentrated to the input saltwater such that monovalent ion concentration of the input saltwater while in the electrodialysis stack is increased.

56. The system of claim 54 or 55 wherein the monovalent salt-concentrating stack comprises alternating monovalent anion exchange membranes and monovalent cation exchange membranes.
